(19) United States
(12) Patent Application Publication
(10) Pub. No.: US 2022/0207953 A1
(43) Pub. Date: Jun. 30, 2022

(54) AUTOMATIC TRANSACTION APPARATUS AND CONTROL METHOD FOR AUTOMATIC TRANSACTION APPARATUS

(71) Applicant: Glory Ltd., Himeji-shi (JP)

(72) Inventors: Shota FUJINAGA, Himeji-shi (JP); Hiroyuki HATAI, Himeji-shi (JP)

(73) Assignee: Glory Ltd., Himeji-shi (JP)

(21) Appl. No.: 17/558,589

(22) Filed: Dec. 22, 2021

(30) Foreign Application Priority Data
Dec. 25, 2020 (JP) 2020-217206

(51) Int. Cl. G07F 9/02; G07F 9/00

(52) U.S. Cl. CPC G07F 9/0235; G07F 9/009

(57) ABSTRACT

An automatic transaction apparatus includes: a display device configured to display an operation screen; a contact sensor configured to detect a contact operation with respect to the operation screen; a non-contact sensor configured to detect a non-contact operation with respect to the operation screen; and processing circuitry configured to accept input with respect to the operation screen by selectively processing first signals from the contact sensor based on the contact operation or second signals from the non-contact sensor based on the non-contact operation.

### CROSS-REFERENCE TO RELATED APPLICATION

This application claims priority under 35 U.S.C. Section 119 to Japanese Patent Application No. 2020-217206 filed Dec. 25, 2020, the disclosure of which is incorporated herein by reference in its entirety.

### BACKGROUND

### 1. Technical Field

The present application relates to an automatic transaction apparatus that performs a predetermined transaction with a user and a control method for the automatic transaction apparatus.

### 2. Disclosure of Related Art

To date, an automatic transaction apparatus that performs a predetermined transaction with a user is used in various situations. For example, at a medical institution, a medical care fee is paid using a patient ID card. In addition, an automatic transaction apparatus is installed as a ticket issuing machine at a station or a store.

In this type of automatic transaction apparatus, input from a user can be accepted by a touch panel. In this case, for example, the touch panel is superposed on the upper side of a liquid crystal panel. When the user touches a selection item displayed on the liquid crystal panel, this selection operation is detected by the touch panel.

### SUMMARY

In an exemplary implementation of the present application, an automatic transaction apparatus includes: a display device configured to display an operation screen; a contact sensor configured to detect a contact operation with respect to the operation screen; a non-contact sensor configured to detect a non-contact operation with respect to the operation screen; and processing circuitry configured to accept input with respect to the operation screen by selectively processing first signals from the contact sensor based on the contact operation or second signals from the non-contact sensor based on the non-contact operation.

### BRIEF DESCRIPTION OF THE DRAWINGS

The above and other objects and new features of the present application will be fully clarified by the following description of the embodiment, when read in conjunction with the accompanying drawings.

FIG. 1A is a perspective view showing the appearance of an automatic transaction apparatus according to Embodiment 1;

FIG. 1B is a side view schematically showing a configuration of an operation/display unit according to Embodiment 1;

FIG. 1C is a plan view schematically showing a configuration example of a non-contact sensor according to Embodiment 1;

FIG. 2A is a side view illustrating a method for detecting an operation position by a contact sensor according to Embodiment 1;

FIG. 2B is a side view illustrating a method for detecting an operation position by the non-contact sensor according to Embodiment 1;

FIG. 3 is a block diagram showing a configuration of the automatic transaction apparatus according to Embodiment 1;

FIG. 4A and FIG. 4B are each a diagram showing a detection position when input with respect to an operation screen is detected by the non-contact sensor, according to Embodiment 1;

FIG. 5 is a flowchart showing switching control between the contact sensor and the non-contact sensor according to Embodiment 1;

FIG. 6 is a diagram showing a display example of an operation screen to be used by a general user, according to Embodiment 1;

FIG. 7 is a diagram showing a display example of the operation screen to be used by the general user, according to Embodiment 1;

FIG. 8 is a diagram showing a display example of an operation screen to be used by a manager, according to Embodiment 1;

FIG. 9A and FIG. 9B are diagrams showing how a detection position by the non-contact sensor shifts from a target position depending on whether a user is short or tall in height, according to Embodiment 1;

FIG. 10A is a flowchart showing correction control of a detection position according to Embodiment 1;

FIG. 10B and FIG. 10C are diagrams showing the configurations of tables to be used for the correction control of the detection position, according to Embodiment 1;

FIG. 11A is a flowchart showing another correction control according to Embodiment 1;

FIG. 11B is a side view illustrating a method for correcting a display position of an operation button in an up-down direction, according to Embodiment 1;

FIG. 12A is a flowchart showing still another correction control according to Embodiment 1;

FIG. 12B is a side view illustrating a method for correcting a response position of the operation button in the up-down direction, according to Embodiment 1;

FIG. 13A is a flowchart showing still another correction control according to Embodiment 1;

FIG. 13B is a diagram illustrating a method for correcting a tilt angle in the up-down direction of the operation/display unit (non-contact sensor), according to Embodiment 1;

FIG. 14 is a flowchart showing switching control of detection means according to Modification 1;

FIG. 15 is a diagram showing a display example of an operation screen to be used by a general user, according to Modification 1;

FIG. 16 is a diagram showing a display example of an operation screen to be used by a manager, according to Modification 1;

FIG. 17 is a flowchart showing switching control of detection means according to Modification 2;

FIG. 18 is a diagram showing a display example of an operation screen for accepting selection of detection means, according to Modification 2;

FIG. 19 is a flowchart showing switching control of detection means according to Modification 3;

FIG. 20A and FIG. 20B are each a diagram showing a configuration example of an operation screen according to Modification 3;

FIG. 20C is a diagram showing the configuration of a table to be used for setting detection means to be used for the operation screen, according to Modification 3;

FIG. 21 is a flowchart showing switching control of detection means according to Modification 4;

FIG. 22A and FIG. 22B are each a diagram showing a configuration example of an operation screen according to Modification 4;

FIG. 22C and FIG. 22D are each a diagram showing the configuration of a table to be used for setting detection means to be used for operation buttons, according to Modification 4;

FIG. 23 is a flowchart showing an acceptance process for input with respect to an operation screen, according to Embodiment 2; and

FIG. 24 is a flowchart showing an acceptance process for input with respect to an operation screen, according to Embodiment 3.

It is noted that the drawings are solely for description and do not limit the scope of the present invention in any way.

### DETAILED DESCRIPTION OF THE DRAWINGS

In conventional automatic transaction apparatuses, various users bring their fingers into contact with the touch panel during transactions. The inventors have recognized that such usage of such conventional devices lacks optimal hygiene.

In view of this problem, the inventors have developed the technology of the present application to provide an automatic transaction apparatus and control method which allow a user to smoothly perform input while considering hygiene.

A first aspect of the present application is directed to an automatic transaction apparatus. The automatic transaction apparatus according to this aspect includes: a display device configured to display an operation screen; a contact sensor configured to detect an operation with respect to the operation screen; a non-contact sensor configured to detect an operation with respect to the operation screen; and a processor configured to accept input with respect to the operation screen by selectively using the contact sensor and the non-contact sensor.

A second aspect of the present application is directed to a control method for an automatic transaction apparatus. This control method includes: displaying an operation screen; and accepting input with respect to the operation screen by selectively using a contact sensor and a non-contact sensor.

A third aspect of the present application is directed to an automatic transaction apparatus. The automatic transaction apparatus according to this aspect includes: a display device configured to display an operation screen; a non-contact sensor configured to detect an operation with respect to the operation screen; a processor configured to accept input with respect to the operation screen by using the non-contact sensor; and a detector capable of acquiring information about an operation direction with respect to the operation screen. Here, the processor corrects a detection position detected by the non-contact sensor or a position of an operation button included in the operation screen, on the basis of the information acquired from a detection result of the detector.

A fourth aspect of the present application is directed to a control method for an automatic transaction apparatus. This control method includes: displaying an operation screen; acquiring information about an operation direction with respect to the operation screen; and correcting a detection position, with respect to the operation screen, detected by a non-contact sensor, or a position of an operation button included in the operation screen, on the basis of the information.

In the above, the “input with respect to the operation screen” broadly includes input in the form of bringing a finger close to the operation button and input in another form of a swipe, a flick, and the like. In addition, the “operation button” broadly includes a button for inputting an instruction, a button for selecting one of selection candidates, an icon, a button for transitioning a screen to another screen, and the like.

Hereinafter, embodiments of the present application will be described with reference to the drawings. In the following, an automatic transaction apparatus that is installed at a medical institution and that is for a user to settle a medical care fee is described as an example of an automatic transaction apparatus.

### Embodiment 1

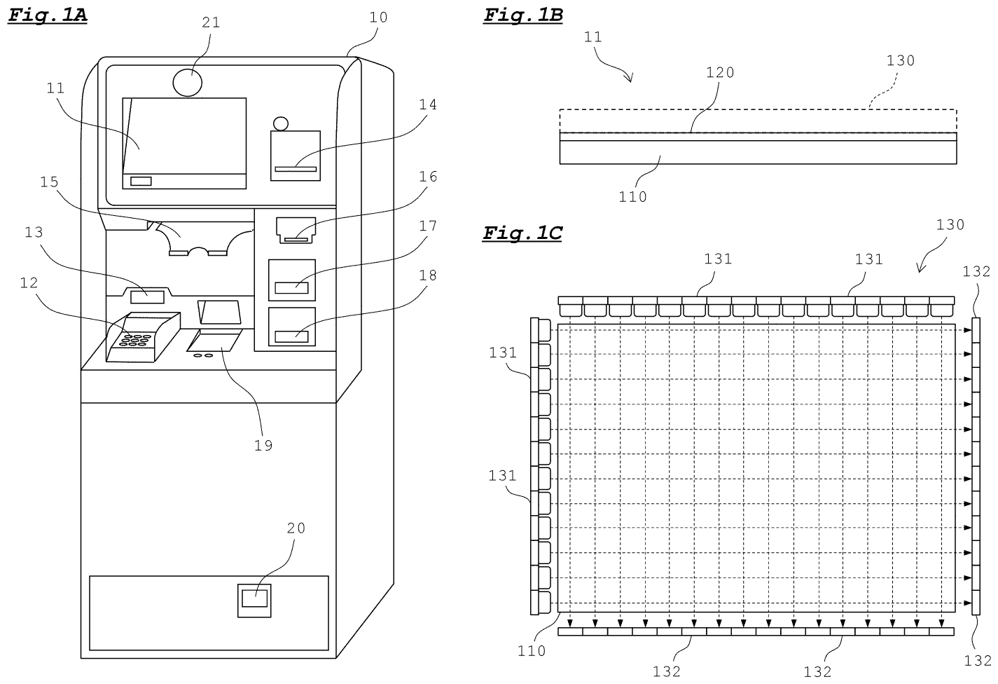

FIG. 1A is a perspective view showing the appearance of an automatic transaction apparatus 10 according to Embodiment 1.

The automatic transaction apparatus 10 is installed at a medical institution. The automatic transaction apparatus 10 is connected to a medical practice system, which is installed in the medical institution, via a relay and an internal communication network (LAN). In addition, the automatic transaction apparatus 10 is connected to a card information processing center (server), which manages payments related to credit cards, via a relay and an external communication network. The connection by the external communication network is, for example, an inline connection by a dedicated line. Alternatively, the connection by the external communication network may be an internet connection.

When settling a medical care fee, the automatic transaction apparatus 10 accepts a patient ID card and transmits patient ID card information including patient ID information, to the medical practice system. Accordingly, medical care fee information associated with the ID information is transmitted from the medical practice system to the automatic transaction apparatus 10, and a settlement process in the automatic transaction apparatus 10 is performed.

In the settlement process, the automatic transaction apparatus 10 accepts a credit card and transmits payment information including a credit card number, to the card information processing center. The payment information is encrypted and transmitted to the card information processing center. In addition to the credit card number, the payment information may include a security code, the alphabet name of the cardholder, and the expiration date of the credit card. Through the transmission of the payment information, a payment process for the medical care fee or the like is performed using the credit card. In the payment process, the automatic transaction apparatus 10 accepts payment in cash and handles banknotes and coins.

The automatic transaction apparatus 10 has a rectangular parallelepiped shape having a height that is about the height of an adult. The automatic transaction apparatus 10 includes an operation/display unit 11, a numeric keypad 12, a barcode reader 13, a first printing unit 14, a second printing unit 15, a card insertion port 16, a banknote depositing unit 17, a banknote dispensing unit 18, a coin depositing/dispensing unit 19, a foreign matter return unit 20, and the camera 21.

The operation/display unit 11 displays predetermined information and also accepts operations from a user. The numeric keypad 12 is used for inputting a personal identification number, and the like. For example, when paying with a credit card, the user inputs a personal identification number of the credit card by using the numeric keypad 12.

The barcode reader 13 reads a barcode printed on a sheet for settling a medical care fee. For example, a barcode for settlement is printed on a numbered ticket issued by a reception machine for accepting medical examinations. The user can use this barcode to settle the medical care fee. When settlement is performed with a credit card or the like, the first printing unit 14 sends out a user copy. When a medical care fee is paid, the second printing unit 15 sends out a receipt. In addition, when an operation for issuing a medical statement is performed on the operation/display unit 11, the second printing unit 15 sends out the medical statement.

The card insertion port 16 is an insertion port for a patient ID card and a credit card. In Embodiment 1, the common card insertion port 16 is provided for both a patient ID card and a credit card.

When a medical care fee is paid in cash, the banknote depositing unit 17 accepts banknotes inserted thereinto. When a medical care fee is paid in cash, the banknote dispensing unit 18 discharges banknotes to be returned. When a medical care fee is paid in cash, the coin depositing/dispensing unit 19 accepts coins inserted thereinto, and discharges coins to be returned. When a foreign matter other than coins is inserted into the coin depositing/dispensing unit 19, the foreign matter return unit 20 discharges the foreign matter.

The camera 21 takes an image of the user operating the automatic transaction apparatus 10. The camera 21 is disposed directly above the operation/display unit 11 and at the center of the width of the operation/display unit 11. The viewing angle and the angle of the camera 21 are set such that an image of the upper body of the user can be substantially taken regardless of the height of the user. The height of the user and the standing position in the right-left direction of the user with respect to the operation/display unit 11 can be detected on the basis of the image taken by the camera 21.

The user performs an operation for payment of a medical care fee or the like, on the operation/display unit 11 according to a screen displayed on the operation/display unit 11. Payment of a medical care fee is made by inserting a patient ID card into the card insertion port 16 or causing the barcode reader 13 to read a barcode printed on a sheet for settlement.

When a patient ID card is inserted into the card insertion port 16, patient ID card information read from the patient ID card is transmitted to the medical practice system, and medical care fee information associated with the patient ID card information is transmitted from the medical practice system to the automatic transaction apparatus 10. Alternatively, when a barcode printed on a sheet for settlement is directed to the barcode reader 13, barcode information read by the barcode reader 13 is transmitted to the medical practice system, and medical care fee information associated with the barcode information is transmitted from the medical practice system to the automatic transaction apparatus 10.

The automatic transaction apparatus 10 displays a screen for settling a monetary amount corresponding to received medical care fee information, on the operation/display unit 11, and prompts the user to select payment in cash or payment with a credit card. Moreover, payment with a debit card may be selectable. The automatic transaction apparatus 10 executes a payment process using a credit card or a payment process by cash according to an operation on the operation/display unit 11. When payment using a credit card is selected, the automatic transaction apparatus 10 accepts the credit card inserted through the card insertion port 16. If a patient ID card has been inserted through the card insertion port 16 when a payment process is started, the automatic transaction apparatus 10 discharges the patient ID card, and then accepts a credit card inserted thereinto. Accordingly, settlement with the credit card is performed.

FIG. 1B is a side view schematically showing a configuration of the operation/display unit 11.

As shown in FIG. 1, the operation/display unit 11 includes a display device 110, a contact sensor 120, and a non-contact sensor 130.

The display device 110 is a display device that displays an image such as a liquid crystal display device. The display device 110 has a rectangular display region in a plan view. The shape of the display region of the display device 110 is not limited to a rectangular shape, and may be another shape such as a square shape.

The contact sensor 120 is a sensor that detects a contact position when a finger of the user touches the surface thereof. The contact sensor 120 is, for example, a pressure sensitive or capacitive touch panel. The contact sensor 120 has a detection region having substantially the same size as that of the display region of the display device 110. The contact sensor 120 is disposed on the upper side of the display device 110 such that the detection region thereof overlaps the display region.

The non-contact sensor 130 is a sensor that detects an entry position when a finger of the user enters a predetermined height range from the surface thereof. The non-contact sensor 130 is composed of, for example, a sensor panel including an infrared light emitter and a light receiver. The non-contact sensor 130 has a detection region having substantially the same size as that of the display region of the display device 110. The non-contact sensor 130 is disposed on the upper side of the contact sensor 120 such that the detection region thereof overlaps the display region.

FIG. 1C is a plan view schematically showing a configuration example of the non-contact sensor 130.

As shown in FIG. 1C, the non-contact sensor 130 has a configuration in which a plurality of pairs of a light emitter 131 and a light receiver 132 are arranged vertically and horizontally. Each light emitter 131 emits infrared light traveling in a straight line, and the light receiver 132 facing the light emitter 131 receives the infrared light. When a finger enters the detection region, the infrared light is blocked by the finger and does not reach the light receiver 132. At this time, both the infrared light traveling in the vertical direction and the infrared light traveling in the horizontal direction are blocked by the finger. The position at which the blocked infrared light in the vertical direction and the blocked infrared light in the horizontal direction intersect each other is detected as the position of the finger. The blocked infrared light is infrared light incident on the light receiver 132 whose output has fallen. Therefore, by monitoring falling of the output of each light receiver 132, the entry position of the finger, that is, the operation position with respect to the screen of the display device 110, is detected.

The non-contact sensor 130 does not necessarily have to have the configuration of FIG. 1C, and may have, for example, a configuration for a method of scanning with infrared light.

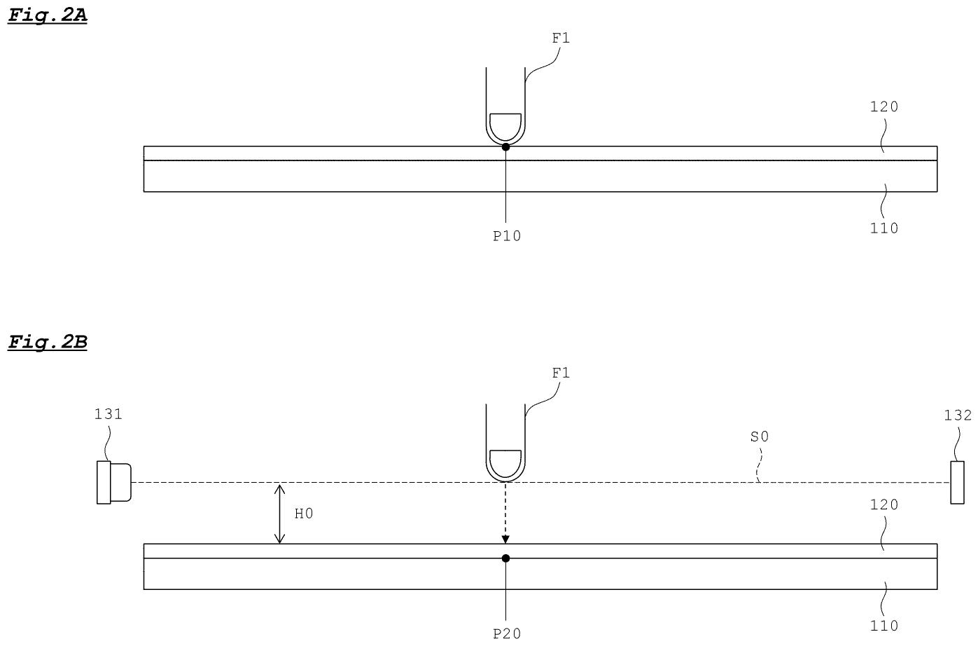

FIG. 2A is a side view illustrating a method for detecting an operation position by the contact sensor 120, and FIG. 2B is a side view illustrating a method for detecting an operation position by the non-contact sensor 130.

As shown in FIG. 2A, in the contact sensor 120, a position at which a finger F1 of the user touches the surface of the contact sensor 120 is detected as a detection position P10. On the other hand, in the non-contact sensor 130, as shown in FIG. 2B, the positions (positions of infrared light) of the light emitters 131 and the light receivers 132 are separated from the contact sensor 120 by a height H0, so that when the finger F1 enters a detection surface S0 at the position of the height H0, a position directly below the entry position is detected as a detection position P20. Therefore, when the non-contact sensor 130 is used, the user can perform an operation with respect to the screen on the display device 110 in a non-contact state.

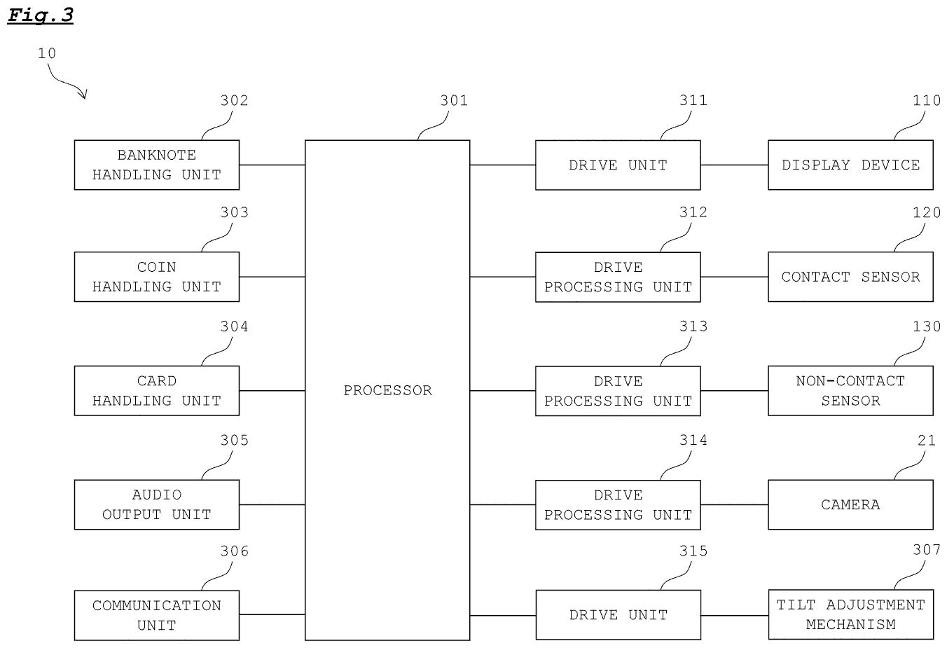

FIG. 3 is a block diagram showing a configuration of the automatic transaction apparatus 10.

In addition to the operation/display unit 11, the numeric keypad 12, the barcode reader 13, the first printing unit 14, and the second printing unit 15 shown in FIG. 1A, the automatic transaction apparatus 10 includes a processor 301, a banknote handling unit 302, a coin handling unit 303, a card handling unit 304, an audio output unit 305, a communication unit 306, and a tilt adjustment mechanism 307.

The processor 301 includes an arithmetic processing circuit such as a CPU (central processing unit) and a memory such as a ROM (read only memory) and a RAM (random access memory), and controls each part according to a program stored in the memory. The processor 301 may include an FPGA (field programmable gate array). In an exemplary implementation, processor 301 includes processing circuitry.

The processing circuitry is used to control any computer-based and cloud-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The functionality of the elements disclosed herein may be implemented using circuitry or processing circuitry which may include general purpose processors, special purpose processors, integrated circuits, ASICs (“Application Specific Integrated Circuits”), conventional circuitry and/or combinations thereof which are configured or programmed to perform the disclosed functionality. Processors are processing circuitry or circuitry as they include transistors and other circuitry therein. The processor may be a programmed processor which executes a program stored in a memory. In the disclosure, the processing circuitry, units, or means are hardware that carry out or are programmed to perform the recited functionality. The hardware may be any hardware disclosed herein or otherwise known which is programmed or configured to carry out the recited functionality. Furthermore, as used herein the terms “circuit” or “circuitry” means one or more circuits, including discrete circuit(s) as well as circuit board(s) and combinations thereof.

The banknote handling unit 302 includes a banknote storage unit for storing banknotes of each denomination and a transport unit for transporting banknotes, and transports banknotes between the banknote storage unit, and the banknote depositing unit 17 and the banknote dispensing unit 18 according to the control from the processor 301. The coin handling unit 303 includes a coin storage unit for storing coins of each denomination and a transport unit for transporting coins, and transports coins between the coin storage unit and the coin depositing/dispensing unit 19 according to the control from the processor 301.

The card handling unit 304 handles a card (patient ID card, credit card) inserted through the card insertion port 16 in FIG. 1A. The audio output unit 305 includes audio output means such as a speaker, and outputs a predetermined audio according to the control from the processor 301.

The communication unit 306 is a communication interface for communicating with the above-described medical practice system and card information processing center. In an exemplary implementation, communication unit 306 includes a network controller, such as an Ethernet PRO network interface card, for interfacing with a network. As can be appreciated, the network can be a public network, such as the Internet, or a private network such as a local area network (LAN) or wide area network (WAN), or any combination thereof and can also include Public Switched Telephone Network (PSTN) or Integrated Services Digital Network (ISDN) sub-networks. The network can also be wired, such as an Ethernet network, universal serial bus (USB) cable, or can be wireless such as a cellular network including EDGE, 3G and 4G wireless cellular systems. The wireless network can also be Wi-Fi, wireless LAN, Bluetooth, or any other wireless form of communication that is known. Additionally, the network controller may be compliant with other direct communication standards, such as Bluetooth, a near field communication (NFC), infrared ray or other.

The tilt adjustment mechanism 307 adjusts the tilt angles in the vertical direction and the horizontal direction of the operation/display unit 11. The tilt adjustment mechanism 307 includes a support mechanism which supports the operation/display unit 11 such that the operation/display unit 11 is rotatable about two shafts (first shaft, second shaft) perpendicular to each other, and a drive mechanism which drives the operation/display unit 11 in each rotation direction. For example, the first shaft is parallel to the horizontal direction, and the second shaft is perpendicular to the first shaft.

The support mechanism includes, for example, an inner frame which supports the operation/display unit 11, an outer frame which supports the inner frame such that the inner frame is rotatable about the first shaft, and a fixed frame which supports the outer frame such that the outer frame is rotatable about the second shaft. The first shaft is fixed to the inner frame, and the second shaft is fixed to the outer frame. The drive mechanism includes a first gear and a first motor which are disposed on the outer frame and which rotate the first shaft, and a second gear and a second motor which are disposed on the fixed frame and which rotate the second shaft. The first motor and the second motor are, for example, stepping motors.

When the first motor is driven, the operation/display unit 11 rotates about the first shaft together with the inner frame. When the second motor is driven, the operation/display unit 11 rotates about the second shaft together with the inner frame and the outer frame. Accordingly, the tilt angles in the vertical direction and the horizontal direction of the operation/display unit 11 are changed. The tilt angle in each direction is set by the drive amount (number of steps) of the first motor or the second motor.

The automatic transaction apparatus 10 further includes drive units 311 and 315 and drive processing units 312, 313, and 314 as components of a circuitry.

The drive unit 311 drives the display device 110 according to the control from the processor 301. Accordingly, a predetermined operation screen is displayed on the display device 110. The drive unit 315 drives the tilt adjustment mechanism 307 according to the control from the processor 301. Accordingly, each tilt angle of the operation/display unit 11 is adjusted as described above.

The drive processing unit 312 drives the contact sensor 120 according to the control from processor 301. In addition, the drive processing unit 312 processes a detection signal of the contact sensor 120, detects an operation position, and outputs the detection result to the processor 301.

The drive processing unit 313 drives the non-contact sensor 130 according to the control from processor 301. In addition, the drive processing unit 313 processes a detection signal of the non-contact sensor 130 (output signal from each light receiver 132), detects an operation position, and outputs the detection result to the processor 301.

The drive processing unit 314 drives the camera 21 according to the control from processor 301. In addition, the drive processing unit 314 processes an imaging signal of the camera 21 to generate a taken image, and outputs the generated taken image to the processor 301.

Meanwhile, as described above, in Embodiment 1, as input means with respect to the operation screen, the non-contact sensor 130 is disposed in addition to the contact sensor 120. With the non-contact sensor 130, input in a non-contact manner is enabled, so that an input form that is excellent in hygiene can be provided. However, with the non-contact sensor 130, as shown in FIG. 2B, input is detected at the height H0 away from the operation screen, so that the detection position may shift from an operation target position due to parallax or the like.

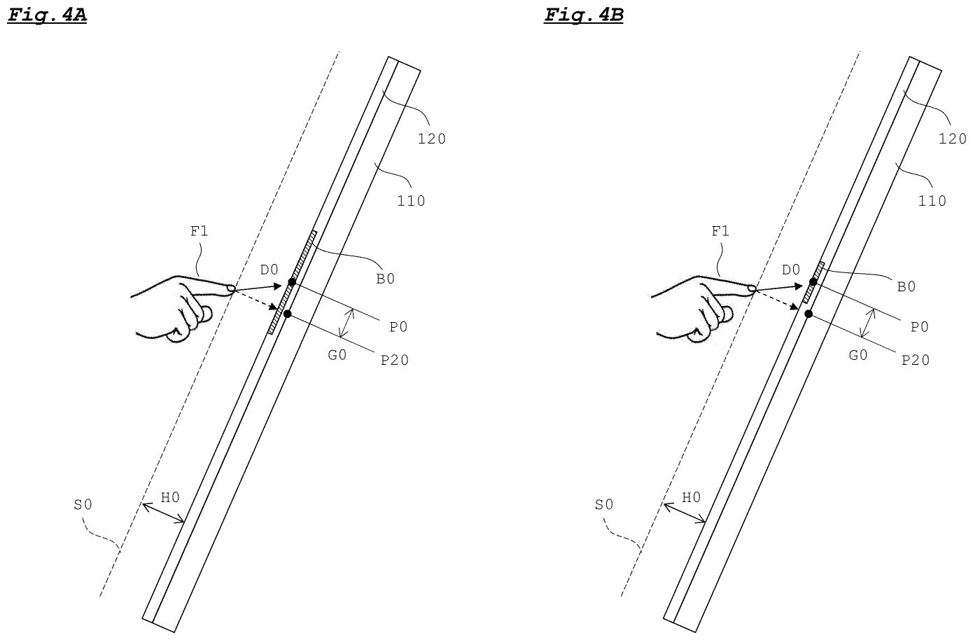

FIG. 4A and FIG. 4B are each a diagram showing the detection position P20 when input with respect to the operation screen is detected by the non-contact sensor 130.

FIG. 4A shows an operation example in the case where the size of an operation button B0 is large, and FIG. 4B shows an operation example in the case where the size of the operation button B0 is small. Here, for example, the user is short in height, so that the finger F1 of the user moves toward the operation button B0 in a direction D0 which is slightly upward from the horizontal direction. In addition, the display device 110 is in a state where the direction of the display surface thereof is tilted slightly upward from the horizontal direction.

In this case, even though the finger F1 moves toward a target position P0 at the center of the operation button B0, the actual detection position P20 is a position shifted downward from the target position P0 by a gap G0. Therefore, in the case where the size (area) of the operation button B0 is large as shown in FIG. 4A, the detection position P20 is included in the range of operation button B0, but in the case where the size (area) of the operation button B0 is small as shown in FIG. 4B, the detection position P20 is outside the range of the operation button B0. Therefore, if the non-contact sensor 130 is used when the size of the operation button B0 is small, it may result in that the operation with respect to the desired operation button cannot be properly performed.

Therefore, in Embodiment 1, input is performed on an operation screen that is to be used by a general user, using the non-contact sensor 130, and input is performed on an operation screen that is to be used by a manager such as a staff member, using the contact sensor 120.

Normally, the operation screen that is to be used by the general user has a small number of operation buttons included in the screen, so that the size of each operation button is large and the intervals between the operation buttons are also wide. Therefore, even if the non-contact sensor 130 is used for the operation screen that is to be used by the general user, input can be appropriately performed. On the other hand, the operation screen that is to be used by the manager has a large number of operation buttons included in the screen, so that the size of each operation button is small and the intervals between the operation buttons are also narrow. Therefore, if the non-contact sensor 130 is used for the operation screen that is to be used by the manager, an operation with respect to the desired operation button cannot be performed properly as described above.

In view of this point, in Embodiment 1, as described above, input is performed on the operation screen that is to be used by the general user, using the non-contact sensor 130, and input is performed on the operation screen that is to be used by the manager such as a staff member, using the contact sensor 120.

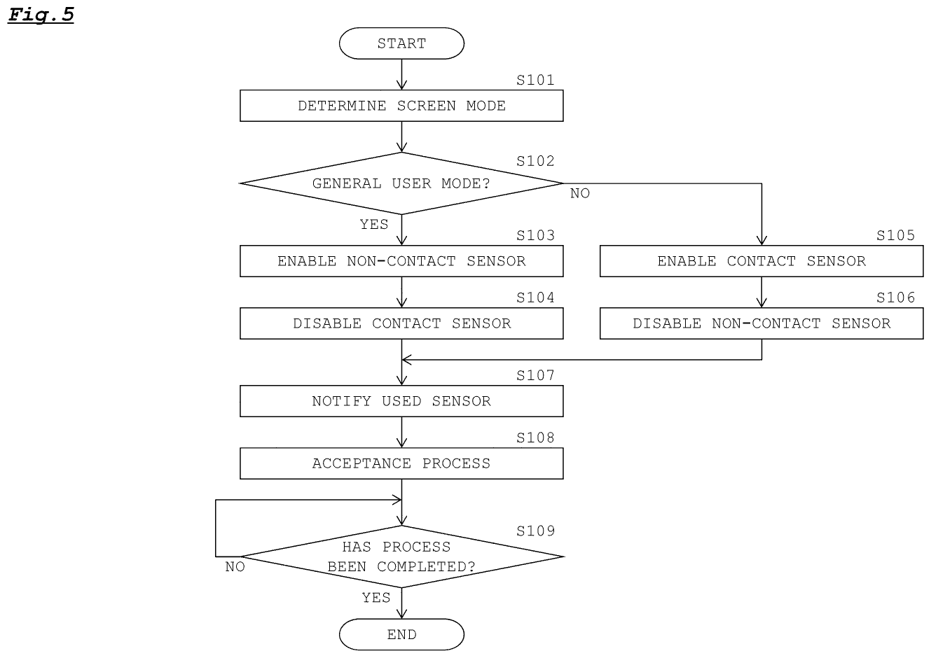

FIG. 5 is a flowchart showing switching control between the contact sensor 120 and the non-contact sensor 130.

The processor 301 determines whether the operation screen to be displayed is the operation screen that is to be used by the general user or the operation screen that is to be used by the manager (S101). If the operation screen to be displayed is the operation screen that is to be used by the general user (S102: YES), the processor 301 enables the non-contact sensor 130 (S103) and disables the contact sensor 120 (S104). Specifically, the processor 301 sets the non-contact sensor 130 to an operating state and sets the contact sensor 120 to a non-operating state.

On the other hand, if the operation screen to be displayed is the operation screen that is to be used by the manager (S102: NO), the processor 301 enables the contact sensor 120 (S105) and disables the non-contact sensor 130 (S106). Specifically, the processor 301 sets the contact sensor 120 to an operating state and sets the non-contact sensor 130 to a non-operating state.

Furthermore, the processor 301 performs a process of notifying the user which of the contact sensor 120 and the non-contact sensor 130 is used as detection means (S107). For example, the processor 301 displays an image that notifies the sensor used as detection means, on the operation screen. The notification method is not limited thereto, and may be a method of outputting a notification voice from the audio output unit 305. In addition, the control in step S107 may be performed such that: only when the non-contact sensor 130 is used as detection means, the user is notified that the non-contact sensor 130 is used as detection means; and when the contact sensor 120 is used, the user is not notified that the contact sensor 120 is used.

After that, the processor 301 performs an acceptance process using the operation screen (S108). Then, if the process using the operation screen is completed (S109: YES), the processor 301 ends the process for the operation screen.

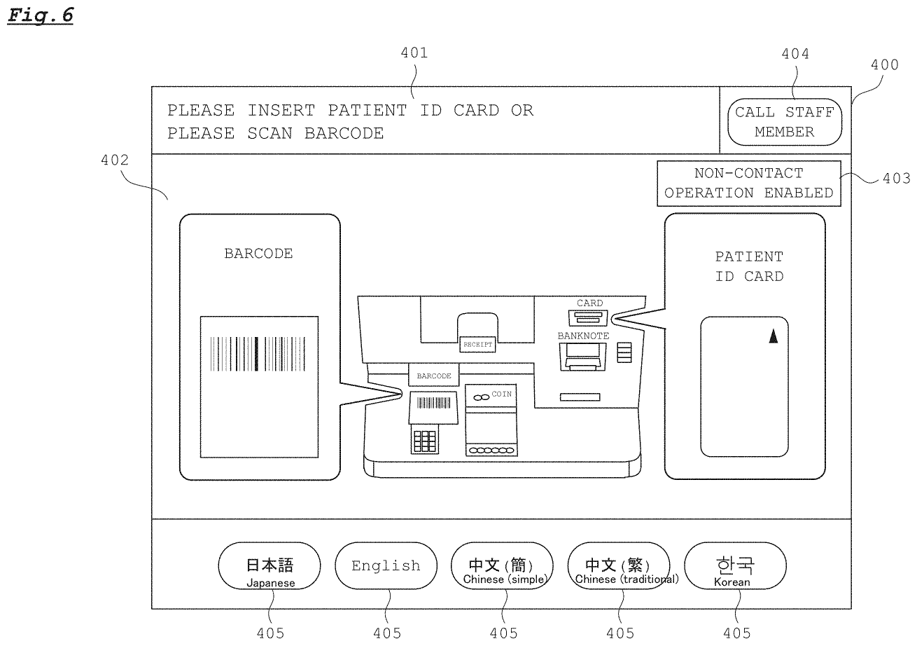

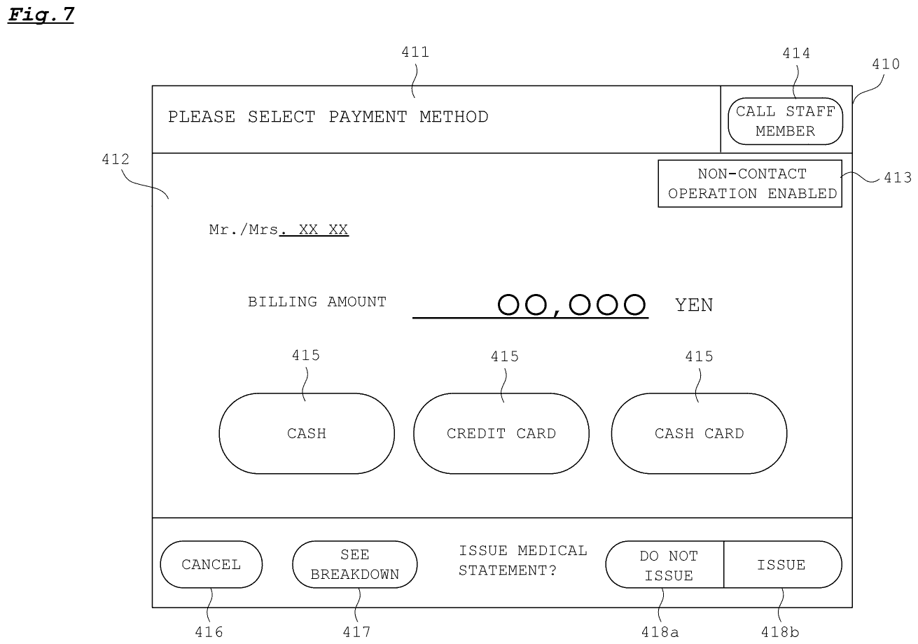

FIG. 6 and FIG. 7 are each a diagram showing a display example of the operation screen that is to be used by the general user.

FIG. 6 shows an operation screen 400 which is displayed first when a medical care fee is settled. The operation screen 400 includes a message 401 which prompts the user to perform a predetermined operation that is to be performed for settlement, and an image 402 which shows a target part for this operation. Here, the user is prompted to perform an operation of inserting a patient ID card into the card insertion port 16 or an operation of causing the barcode reader 13 to read a barcode printed on a numbered ticket or the like. The user performs one of these operations with reference to the message 401 and the image 402.

The operation screen 400 further includes an image 403 which notifies that an operation with respect to the operation screen 400 is performed in a non-contact manner, and operation buttons 404 and 405. The operation button 404 is a button for calling a staff member, and the five operation buttons 405 are buttons for switching the language used for the operation screen 400. By referring to the image 403, the user grasps that an operation with respect to the operation button 404 or 405 can be performed in a non-contact manner. Then, the user performs an operation with respect to the operation button 404 or 405 in a non-contact manner as appropriate.

When the user performs an operation prompted by the message 401 on the operation screen 400 of FIG. 6, an operation screen 410 of FIG. 7 is displayed.

The operation screen 410 includes a message 411 which prompts the user to select a payment method and an image 412 which notifies the user of a billing amount. The operation screen 410 further includes an image 413 which notifies that an operation with respect to the operation screen 410 is performed in a non-contact manner, and operation buttons 414, 415, 416, 417, 418a, and 418b. The operation button 414 is a button for calling a staff member, and the three operation buttons 415 are buttons for selecting a payment method. In addition, the operation button 416 is a button for canceling an operation, and the operation button 417 is a button for displaying the breakdown of a medical care fee. Furthermore, the operation buttons 418a and 418b are buttons for selecting whether or not to issue a medical statement.

By referring to the image 413, the user grasps that an operation with respect to the operation button 414 to 417, 418a, or 418b can be performed in a non-contact manner. Then, the user operates a desired operation button out of the three operation buttons 415 in a non-contact manner. Accordingly, the operation screen 410 switches to a screen corresponding to the selected payment method. The user pays the medical care fee according to the switched screen.

Moreover, the user operates the operation button 416 when canceling an operation, and the user operates the operation button 417 when viewing the breakdown of the medical care fee. Furthermore, the user operates either one of the operation buttons 418a and 418b depending on whether or not to issue a medical statement. The user also performs operations with respect to these operation buttons in a non-contact manner. Accordingly, a screen corresponding to each operation button is displayed.

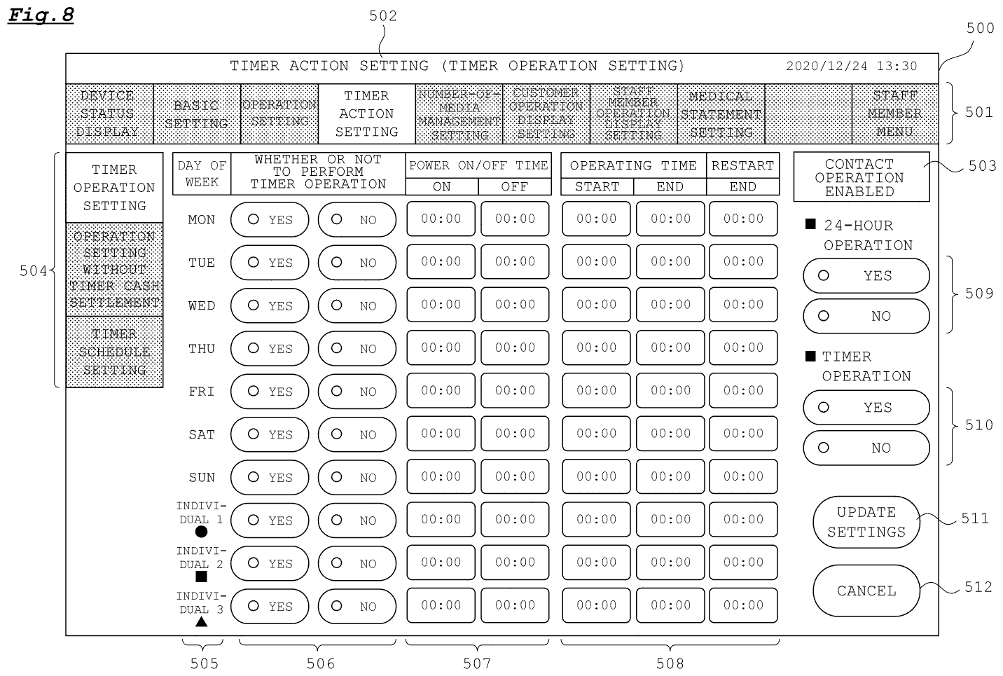

FIG. 8 is a diagram showing a display example of an operation screen 500 which is to be used by the manager

The operation screen 500 includes a tab 501 for selecting settings that are to be made by the manager. In the example of FIG. 8, a tab of “timer action setting” is selected, and a notation 502 indicating that the tab of “timer action setting” is selected is displayed. A region below the tab 501 includes various buttons for making timer action setting. In addition, an image 503 which notifies that operations with respect to these buttons are accepted through contact operations on the operation screen 500, is displayed. By referring to the image 503, the manager grasps that operations with respect to various buttons are accepted through contact operations.

The region below the tab 501 further includes a tab 504 for selecting settings. Here, “timer operation setting” at the top is selected. In addition, various buttons for making selected settings are displayed in a region on the right side of the tab 504. The region on the right side of the tab 504 includes an item 505 which displays the day of the week to be set, operation buttons 506 for selecting whether or not to perform timer operation on each day of the week, operation buttons 507 for setting power on/off times on each day of the week, and operation buttons 508 for setting operation start/end times and restart/end times on each day of the week. Furthermore, a rightmost region includes operation buttons 509 for selecting whether or not to operate for 24 hours, operation buttons 510 for selecting whether or not to perform the timer operation that is set for each day of the week, an operation button 511 for updating the settings to the contents of the operation, and an operation button 512 for canceling an operation.

As shown in FIG. 8, the operation screen 500 which is to be used by the manager has a large number of operation buttons, so that the sizes of the operation buttons (including tabs) are small and the intervals between the operation buttons are also narrow. Therefore, when the operation screen is the operation screen for the manager, input detection is performed using the contact sensor 120 under the control of FIG. 5. Accordingly, the manager can accurately perform an operation.

On the other hand, as shown in FIG. 6 and FIG. 7, the operation screens 400 and 410 which are to be used by the general user each have a small number of operation buttons, so that the sizes of the operation buttons (including tabs) are large and the intervals between the operation buttons are also wide. Therefore, when the operation screen is the operation screen for the general user, input detection is performed using the non-contact sensor 130 under the control of FIG. 5. Accordingly, the general user can properly perform an operation with respect to the operation button while improving hygiene.

<Other Control>

As described with reference to FIG. 4A and FIG. 4B, the detection position P20 by the non-contact sensor 130 shifts from the target position P0 at which the user tries to perform an operation, by the gap G0. Thus, it can be assumed that an erroneous operation may occur when the non-contact sensor 130 is used. Therefore, it can be said that it is preferable that control for suppressing such an erroneous operation is further performed when the non-contact sensor 130 is used. Hereinafter, this control will be described.

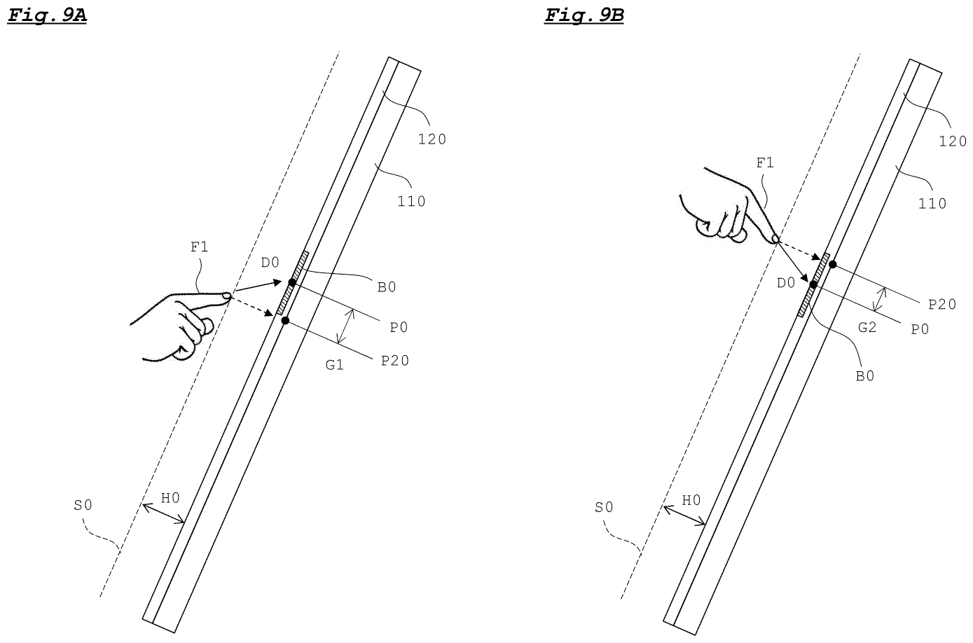

FIG. 9A and FIG. 9B are diagrams showing how the detection position P20 by the non-contact sensor 130 shifts from the target position P0 depending on whether a user is short or tall in height.

FIG. 9A illustrates the case where a short user performs an operation. A gap G1 between the detection position P20 and the target position P0 in this case is equal to the gap G0 in FIG. 4A and FIG. 4B.

On the other hand, when a tall user performs an operation, as shown in FIG. 9B, the direction D0 in which the finger F1 moves is a downward direction since the position of the eyes of the user is high. The direction in which the detection position P20 shifts from the target position P0 is opposite to that in the case of FIG. 9A, and the magnitude of a gap G2 is also different from that in the case of FIG. 9A.

As described above, the shift direction and the shift amount in the up-down direction between the detection position P20 and the target position P0 change according to the operation direction in the up-down direction depending on the height of the user. Therefore, by acquiring the shift direction and the shift amount in the up-down direction for each user's height and correcting the detection position P20 according to the acquired shift direction and shift amount, a corrected detection position P20′ can be closer to the target position P0.

FIG. 9A and FIG. 9B each show the relationship between the height and the position shift in the up-down direction, but the standing position in the right-left direction of the user and the position shift in the right-left direction also have a similar relationship.

That is, when the user performs an operation from the right side of the operation screen, the shift amount (gap) in the right-left direction between the detection position P20 and the target position P0 increases as the user moves away to the right side. In addition, when the user performs an operation from the left side of the operation screen, the shift amount (gap) in the right-left direction between the detection position P20 and the target position P0 increases as the user moves away to the left side. Furthermore, the shift direction in the right-left direction of the detection position P20 with respect to the target position P0 is reversed depending on whether the user operates from the right side of the operation screen or from the left side of the operation screen. Therefore, by acquiring the shift direction and the shift amount in the right-left direction for each standing position in the right-left direction (operation direction in the right-left direction) of the user, and correcting the detection position P20 according to the acquired shift direction and shift amount, a corrected detection position P20′ can be closer to the target position P0.

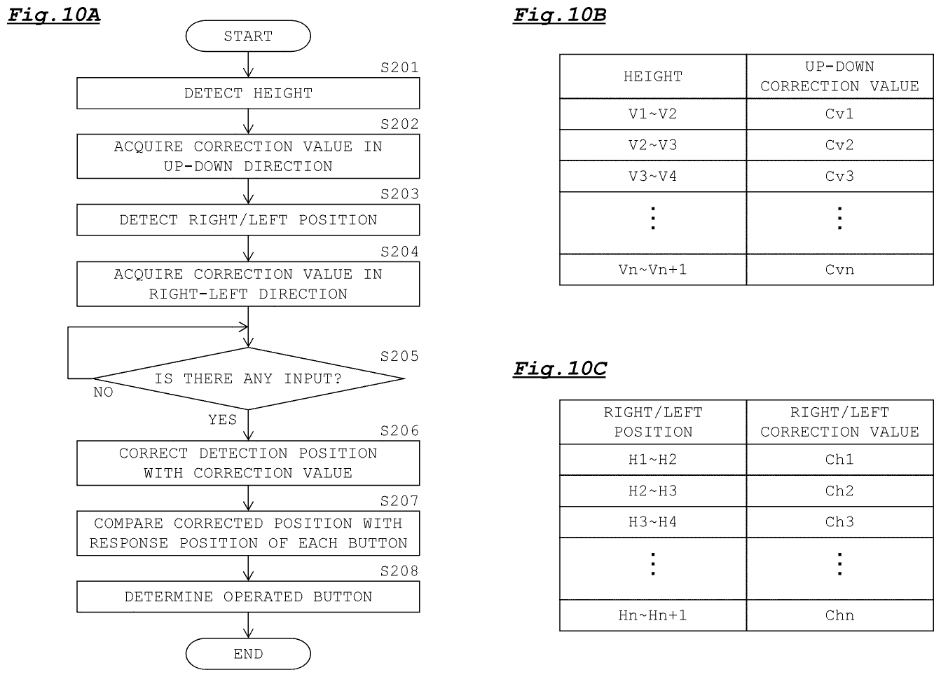

FIG. 10A is a flowchart showing correction control of the detection position P20.

When detecting input with respect to the operation screen using the non-contact sensor 130, the processor 301 detects the height of the user from an image taken by the camera 21 (S201), and acquires a correction value in the up-down direction corresponding to this height (S202). In addition, the processor 301 detects the standing position in the right-left direction of the user with respect to the front position of the operation screen from the image taken by the camera 21 (S203), and acquires a correction value in the right-left direction corresponding to this standing position (S204).

For example, the processor 301 holds tables shown in FIG. 10B and FIG. 10C in advance.

In the table of FIG. 10B, a range of the height and a correction value in the up-down direction are held in association with each other. For example, a correction value Cv1 is associated with a range where the height is not less than V1 and less than V2, and a correction value Cv2 is associated with a range where the height is not less than V2 and less than V3. In addition, in the table of FIG. 10C, a range of the standing position in the right-left direction and a correction value in the right-left direction are held in association with each other. For example, a correction value Ch1 is associated with a range where a shift of the standing position in the right-left direction with respect to the front direction is not less than H1 and less than H2, and a correction value Ch2 is associated with a range where a shift of the standing position in the right-left direction with respect to the front direction is not less than H2 and less than H3. Each correction value is given a positive or negative sign indicating the direction of the shift, that is, the direction of the correction, together with a correction amount corresponding to the magnitude of the shift.

After that, the processor 301 determines whether or not input with respect to the operation screen has been detected (S205). If input has been detected (S205: YES), the processor 301 corrects the detection position P20 by the non-contact sensor 130, in the up-down direction and the right-left direction using the correction values acquired in step S202 and S204, and acquires the corrected detection position P20′ (S206). Then, the processor 301 compares the corrected detection position P20′ with a response position of each operation button in the operation screen (S207), and determines the operated operation button according to the comparison result (S208).

Here, the response position is set, for example, to the center position of each operation button, and when the corrected detection position P20′ is included in a region corresponding to the size of each operation button from the response position, it is determined that the operation button has been operated. When the corrected detection position P20′ is not included in any of the regions of the operation buttons, it is determined in step S208 that there is no operated button.

Steps S205 to S208 are repeatedly executed until the user completes a series of processes.

In the above, the correction values in the up-down direction and the right-left direction are acquired using the tables of FIG. 10B and FIG. 10C, but correction values in the up-down direction and the right-left direction may be calculated from the height and the position in the right-left direction using a predetermined arithmetic expression.

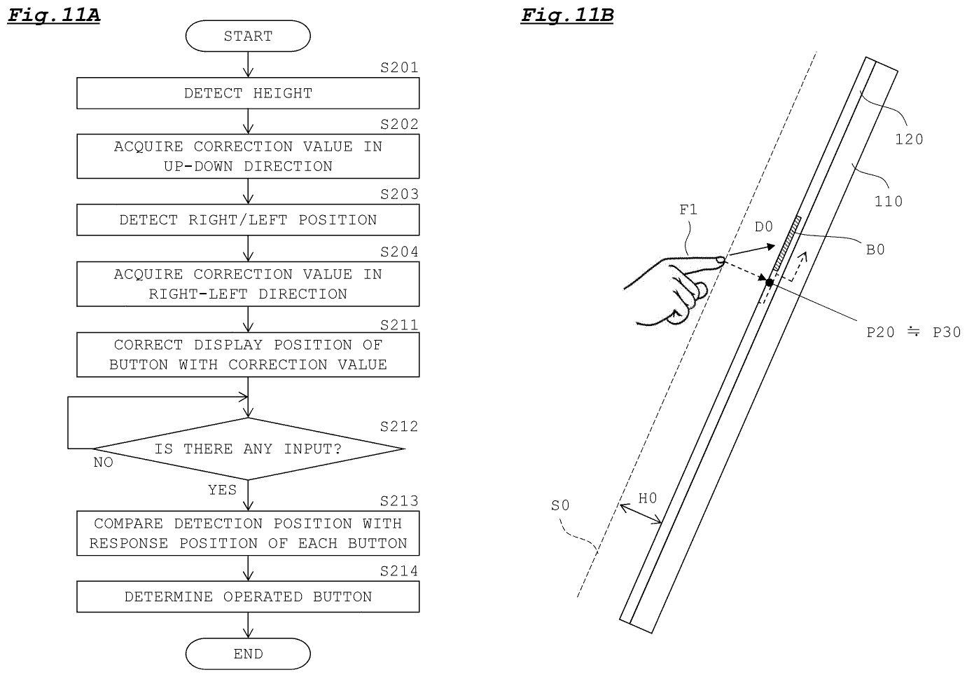

FIG. 11A is a flowchart showing other correction control.

In the correction control of FIG. 10A, the detection position P20 is corrected on the basis of the height and the standing position in the right-left direction of the user, but in the correction control of FIG. 11A, the display position of each operation button is corrected on the basis of the height and the standing position in the right-left direction of the user. In this case, the response position of each operation button is not corrected, and only the display position of each operation button is corrected.

The processes in steps S201 to S204 are the same as those in the case of FIG. 10A. The processor 301 corrects the display position of each operation button on the basis of the correction values acquired in steps S202 and S204 (S211).

FIG. 11B is a side view illustrating a method for correcting the display position of the operation button B0 in the up-down direction.

The display position of the operation button B0 shown by a broken line in FIG. 11B is moved upward according to the height. At this time, the response position of the operation button B0 is maintained at a response position P30 of the operation button B0 shown by a broken line. When the user moves the finger F1 toward the display position after the movement of the operation button B0, the detection position P20 by the non-contact sensor 130 is near the center position in the up-down direction of the operation button B0 before the movement, as shown by a dashed arrow in FIG. 11B. Accordingly, the response position P30 and the detection position P20 become closer to each other in the up-down direction, and the operation with respect to the operation button is more properly detected. The display position in the right-left direction of the operation button B0 is also similarly corrected according to the standing position of the user.

Referring back to FIG. 11A, after the display position of each operation button is corrected as described above, the processor 301 determines whether or not input with respect to the operation screen has been detected (S212). If input has been detected (S212: YES), the processor 301 compares the detection position P20 by the non-contact sensor 130 with the response position of each operation button in the operation screen (S213), and determines the operated operation button according to the comparison result (S214). The method for determining the operation button is the same as in the case of FIG. 10A. In this control as well, the processor 301 repeatedly executes the processes in steps S211 to S214 until the user completes a series of processes.

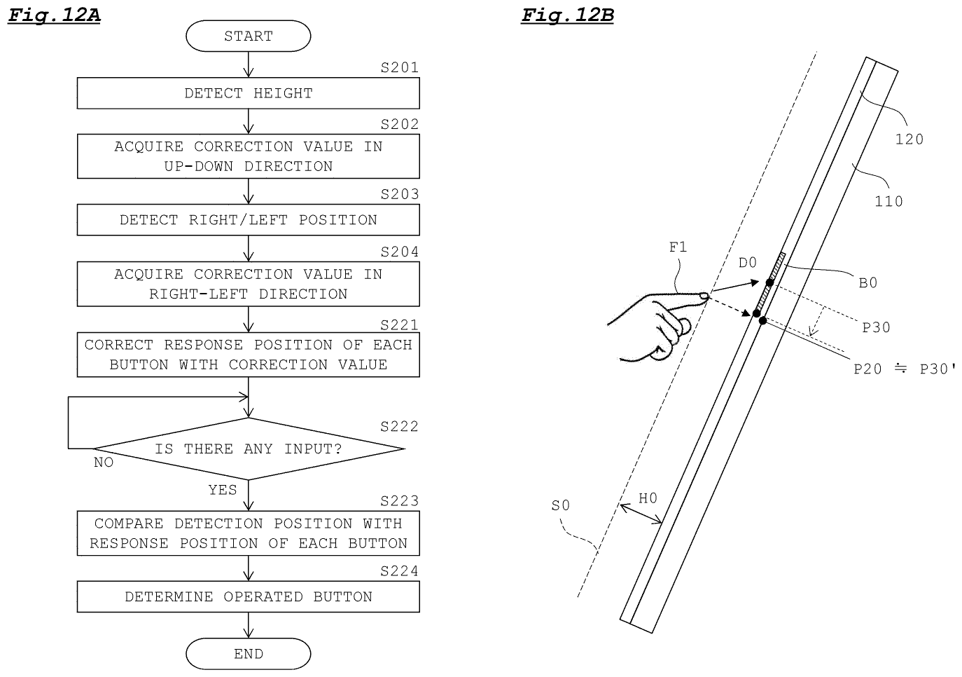

FIG. 12A is a flowchart showing still another correction control.

In the correction control of FIG. 10A, the detection position P20 is corrected on the basis of the height and the standing position in the right-left direction of the user, but in the correction control of FIG. 12A, the response position of each operation button is corrected on the basis of the height and the standing position in the right-left direction of the user.

The processes in steps S201 to S204 are the same as those in the case of FIG. 10A. The processor 301 corrects the response position of each operation button on the basis of the correction values acquired in steps S202 and S204 (S221).

FIG. 12B is a side view illustrating a method for correcting the response position P30 of the operation button B0 in the up-down direction.

The response position P30 of the operation button B0 shown in FIG. 12B is moved downward according to the height, and corrected to the response position P30′. At this time, the display position of the operation button B0 is not moved but maintained as it is. When the user moves the finger F1 toward the display position of the operation button B0, the detection position P20 in the up-down direction by the non-contact sensor 130 is near the corrected response position P30′. Accordingly, the corrected response position P30′ and the detection position P20 become closer to each other in the up-down direction, and the operation with respect to the operation button is more properly detected. The response position in the right-left direction of the operation button B0 is also similarly corrected according to the standing position of the user.

Referring back to FIG. 12A, after the response position P30 of each operation button is corrected as described above, the processor 301 determines whether or not input with respect to the operation screen has been detected (S222). If input has been detected (S222: YES), the processor 301 compares the detection position P20 by the non-contact sensor 130 with the corrected response position P30′ of each operation button in the operation screen (S223), and determines the operated operation button according to the comparison result (S224). The method for determining the operation button is the same as in the case of FIG. 10A. In this control as well, the processor 301 repeatedly executes the processes in steps S221 to S224 until the user completes a series of processes.

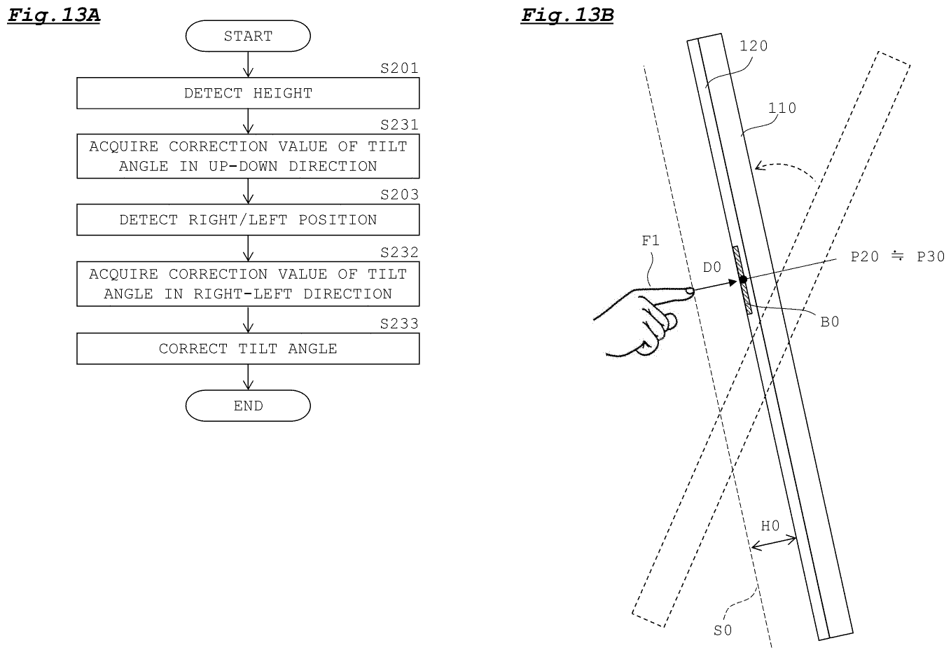

FIG. 13A is a flowchart showing still another correction control.

In the control method of FIG. 13A, the tilt angle of the operation/display unit 11 is corrected according to the height and the standing position in the right-left direction of the user.

The processes in steps S201 and S203 are the same as those in FIG. 10A. The processor 301 acquires a correction value of the tilt angle in the up-down direction of the operation/display unit 11 (non-contact sensor 130) according to the height of the user acquired in step S201 (S231). In addition, the processor 301 acquires a correction value of the tilt angle in the right-left direction of the operation/display unit 11 (non-contact sensor 130) according to the standing position in the right-left direction of the user acquired in step S203 (S232). Then, the processor 301 corrects the tilt angles in the up-down direction and the right-left direction of the operation/display unit 11 (non-contact sensor 130) according to the acquired correction value of the tilt angle in each direction (S233).

FIG. 13B is a diagram illustrating a method for correcting the tilt angle in the up-down direction of the operation/display unit 11 (non-contact sensor 130).

As shown in FIG. 13B, the processor 301 changes the tilt angle in the up-down direction of the operation/display unit 11 (non-contact sensor 130) according to the height of the user such that the direction D0 in which the finger F1 of the user moves becomes closer to being perpendicular to the operation screen. Accordingly, the detection position P20 of the finger F1 by the non-contact sensor 130 is less likely to shift from the operation target position, and the detection position P20 and the response position P30 of the operation button B0 to be operated become closer to each other in the up-down direction. The tilt angle in the right-left direction of the operation/display unit 11 (non-contact sensor 130) is also similarly changed according to the standing position in the right-left direction of the user such that the direction D0 in which the finger F1 of the user moves becomes closer to being perpendicular to the operation screen.

In the correction control of FIG. 13A as well, a table in which a height and a correction value of the tilt angle in the up-down direction are associated with each other, and a table in which a standing position in the right-left direction and a tilt angle in the right-left direction are associated with each other, similar to the case of FIG. 10B and FIG. 10C, can be used. In this case as well, similar to the case of FIG. 10A, correction values of the tilt angles in the up-down direction and the right-left direction may be calculated from the height and the position in the right-left direction of the user using a predetermined arithmetic expression.

In the correction control of FIG. 13A, since the detection position P20 becomes closer to the response position P30 of the operation button, it can be more accurately determined that the operation button to be operated has been operated.

The correction control of FIG. 13A may be used simultaneously with the correction control of FIG. 10A, FIG. 11A, or FIG. 12A. Accordingly, an operation with respect to the operation button can be more accurately detected.

In the control examples shown in FIG. 10A to FIG. 13B, the operation direction with respect to the operation screen, that is, the direction D0 in which the finger F1 of the user moves toward the operation screen, is indirectly estimated from the height and the standing position in the right-left direction of the user, and the height and the standing position in the right-left direction are acquired as information about the operation direction in the up-down direction and the operation direction in the right-left direction. However, the information about the operation direction is not limited thereto, and, for example, the processor 301 may analyze an image taken by the camera 21, directly detect the operation direction with respect to the operation screen, that is, the direction D0 in which the finger F1 of the user moves toward the operation screen, and acquire this detection result as the information about the operation direction.

In this case, in the above respective tables, for example, ranges of the operation direction in the up-down direction and the operation direction in the right-left direction are associated with the respective correction values. In addition, in this case, the operation direction is dynamically detected according to the operation motion of the user with respect to the operation screen, so that the operation/display unit 11 is tilted according to the operation of the user in the control of FIG. 13A and FIG. 13B.

By directly detecting the operation direction with respect to the operation screen, that is, the direction D0 in which the finger F1 of the user moves toward the operation screen as described above, each correction can be more accurately performed. Therefore, the user can more favorably perform an operation with respect to the operation button through the non-contact sensor 130.

<Effects of Embodiment 1>

The processor 301 selectively uses the contact sensor 120 and the non-contact sensor 130 and accepts input with respect to the operation screen. Accordingly, the user can perform input with respect to the operation screen using the non-contact sensor 130 in addition to the contact sensor 120. Therefore, the user can smoothly perform an operation with respect to the operation screen while suppressing hygiene problems.

As shown in FIG. 5, the processor 301 switches the sensor to be used to accept input with respect to the operation screen, between the contact sensor 120 and the non-contact sensor 130, on the basis of the switching condition (S102) that specifies in advance which of the contact sensor 120 or the non-contact sensor 130 is to be used (S103 to S106).

Here, the switching condition (S102) is a condition that if the operation screen is the screen to be operated by the general user (S102: YES), the non-contact sensor 130 is used (S103, S104), and if the operation screen is the screen to be operated by the manager (S102: NO), the contact sensor 120 is used (S105, S106).

In general, the operation screen (FIG. 8) to be operated by the manager includes a large number of operation buttons, so that the size of each operation button is small and the intervals between the operation buttons are also narrow. On the other hand, as for the non-contact sensor 130, since a finger does not directly touch the operation screen, a shift (gap G0) is likely to occur between the target position P0 at which the user tries to perform an operation and the detection position P20 at which the finger is actually detected by the non-contact sensor 130, as shown in FIG. 4A and FIG. 4B. Therefore, if the non-contact sensor 130 is used for the operation screen to be operated by the manager, an erroneous operation is likely to occur.

According to the above condition (S102), if the operation screen is the operation screen to be operated by the manager, the contact sensor 120 is used. Thus, the above erroneous operation is suppressed. On the other hand, if the operation screen is the operation screen to be operated by the general user, the non-contact sensor 130 is used. Thus, hygiene problems are avoided. As described above, according to the above condition, it is possible to avoid hygiene problems when the general user operates the operation screen, while suppressing an erroneous operation when the manager operates the operation screen.

In step S107 of FIG. 5, the processor 301 notifies the user whether the operation screen is the screen on which an operation is accepted by the contact sensor 120 or the screen on which an operation is accepted by the non-contact sensor 130 (images 403, 413, and 503 in FIG. 6, FIG. 7, and FIG. 8). Accordingly, the user can grasp by which of the contact sensor 120 or the non-contact sensor 130 an operation with respect to the operation screen that the user tries to perform is accepted. Therefore, the user can smoothly perform an operation with respect to the operation screen.

The automatic transaction apparatus 10 includes the detector (camera 21) which detects at least either one of the height of the user and the position of the user in the right-left direction. When accepting input through the non-contact sensor 130, the processor 301 corrects the detection position detected by the non-contact sensor 130 or the position of each operation button included in the operation screen, on the basis of the detection result of the detector (camera 21) (FIG. 10A: step S206, FIG. 11A: step S211).

In general, in the non-contact sensor 130, as shown in FIG. 9A and FIG. 9B, when the finger F1 is positioned at a position separated from the operation screen by a predetermined distance, the position on the screen directly below the finger F1 is detected as the detection position P20. However, for example, when the finger F1 of the user is moved diagonally with respect to the operation screen and an operation is performed thereto, a shift (gap G1, G2) occurs between the target position P0 on the operation screen toward which the finger F1 moves and the detection position P20 detected by the non-contact sensor 130. This shift (gap G1, G2) becomes larger as the angle in the moving direction D0 of the finger F1 with respect to the operation screen becomes more acute. Here, the angle in the moving direction of the finger F1 with respect to the operation screen changes according to the height and the standing position of the user. That is, the position shift in the up-down direction between the target position P0 and the detection position P20 changes according to the height of the user, and the position shift in the right-left direction between the target position P0 and the detection position P20 change according to the position in the right-left direction of the user with respect to the operation screen.

In the correction control of FIG. 10A and FIG. 11A, the height and the position in the right-left direction of the user are detected (S201) by the detector (camera 21), and the detection position P20 detected by the non-contact sensor 130 or the position of each operation button included in the operation screen is corrected on the basis of the detection result. Accordingly, the position shift between the corrected detection position P20 and the target position P0 is suppressed, and the detection position P20 is likely to be properly included in the position of the operation button to be operated on the operation screen. Therefore, the user can properly operate the target operation button regardless of their height and standing position.

In the correction control of FIG. 13A, when accepting input through the non-contact sensor 130, the processor 301 adjusts the tilt angle of the operation screen on the basis of the detection results of the height of the user and the position of the user in the right-left direction (S233). In this control, as shown in FIG. 13B, the tilt angle of the operation screen is adjusted according to the height and the standing position of the user such that the finger F1 of the user moves more perpendicularly toward the operation screen. Accordingly, the position shift between the detection position P20 detected by the non-contact sensor 130 and the target position P0 toward which the finger of the user moves can be suppressed. Therefore, the user can properly perform an operation with respect to the operation screen regardless of their height and standing position.

As shown in FIG. 6 and FIG. 7, it is preferable that the operation buttons to which input is accepted by the non-contact sensor 130 are adjacent to each other only in the horizontal direction on the operation screen.

Normally, the user often stands substantially in the front direction of the operation screen and performs an operation with respect to the operation screen. In this case, the detection position by the non-contact sensor often more greatly shifts in the up-down direction than in the right-left direction, from the target position toward which the finger of the user moves. On the other hand, with the above configuration, since the operation buttons to which input is accepted by the non-contact sensor 130 are adjacent to each other only in the horizontal direction as shown in FIG. 6 and FIG. 7, even if the detection position P20 and the target position P0 shift from each other in the up-down direction as shown in FIG. 4A and FIG. 4B, the operation buttons other than the target operation button are less likely to be erroneously operated. Therefore, the user can smoothly perform an operation with respect to the operation button through the non-contact sensor 130.

<Modification 1>

In Embodiment 1 described above, the detection means is switched and set between the non-contact sensor 130 and the contact sensor 120 on the basis of whether the operation screen is to be used by the general user or the manager. On the other hand, in Modification 1, after this setting, the user can optionally switch the detection means between the non-contact sensor 130 and the contact sensor 120.

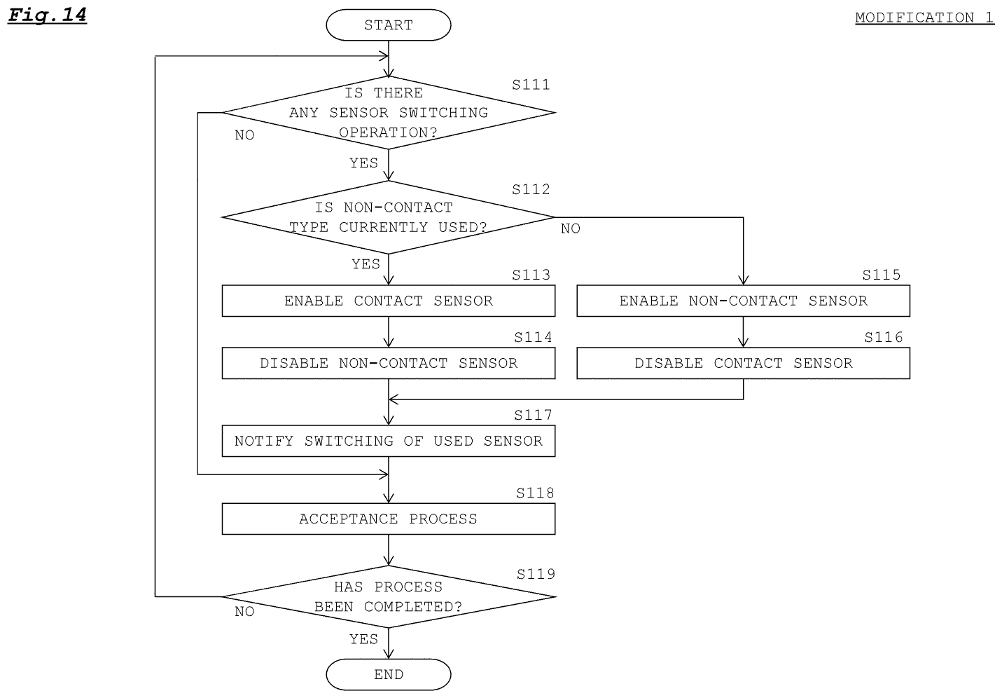

FIG. 14 is a flowchart showing switching control of detection means according to Modification 1.

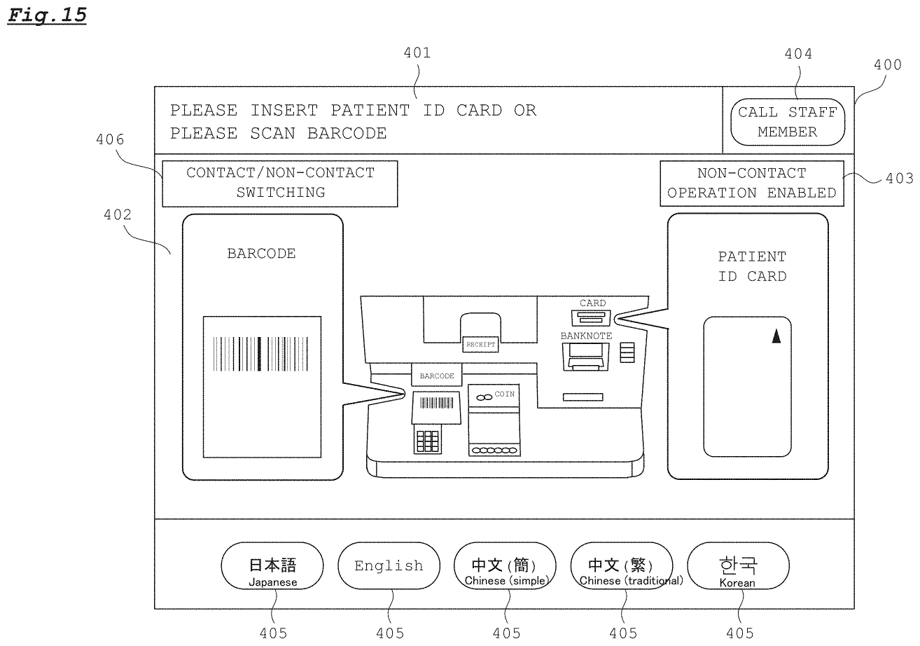

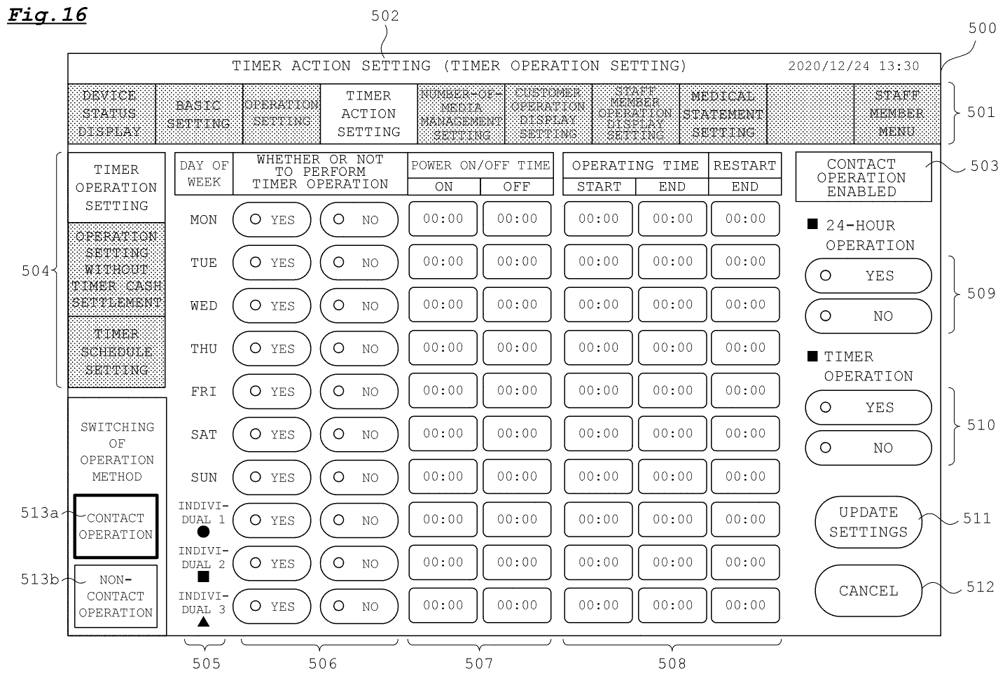

The processor 301 determines whether or not an operation for switching the detection means has been performed (S111). For example, as shown in FIG. 15, the operation screen 400 to be operated by the general user includes an operation button 406 for switching the detection means. In addition, as shown in FIG. 16, the operation screen 500 to be operated by the manager includes operation buttons 513a and 513b for switching the detection means. Each user can switch the currently used detection means to the other detection means by operating these operation buttons. In step S111 of FIG. 14, it is determined whether or not these operation buttons have been operated.

When an operation for switching the detection means has been performed (S111: YES), if the non-contact sensor 130 is currently used (S112: YES), the processor 301 enables the contact sensor 120 and disables the non-contact sensor 130 (S113, S114), and if the contact sensor 120 is currently used (S112: NO), the processor 301 enables the non-contact sensor 130 and disables the contact sensor 120 (S115, S116). Then, the processor 301 notifies that the detection means has been switched to the other detection means (S117). For example, the processor 301 switches the contents of the image 403, 503 of FIG. 15 or FIG. 16 to the contents for the other detection means. At the same time, the switching of the detection means may be notified by voice.

After that, the processor 301 performs an acceptance process using the operation screen (S118). Then, if the process using the operation screen is completed (S119: YES), the processor 301 ends the process for the operation screen.

In the control of FIG. 14, at the time of a transaction process or a setting process, the user can specify the sensor (detection means) employing the method desired by the user. For example, when the user desires to prioritize hygiene, the user can specify the non-contact sensor 130. When the user desires to prioritize reliable operation, the user can specify the contact sensor 120. Accordingly, the user can perform an operation with respect to the operation screen by using the sensor employing the method desired by the user.

<Modification 2>

In Modification 1 described above, switching of the detection means is accepted during a transaction or setting operation. On the other hand, in Modification 2, switching of the detection means is accepted at the start of a transaction.

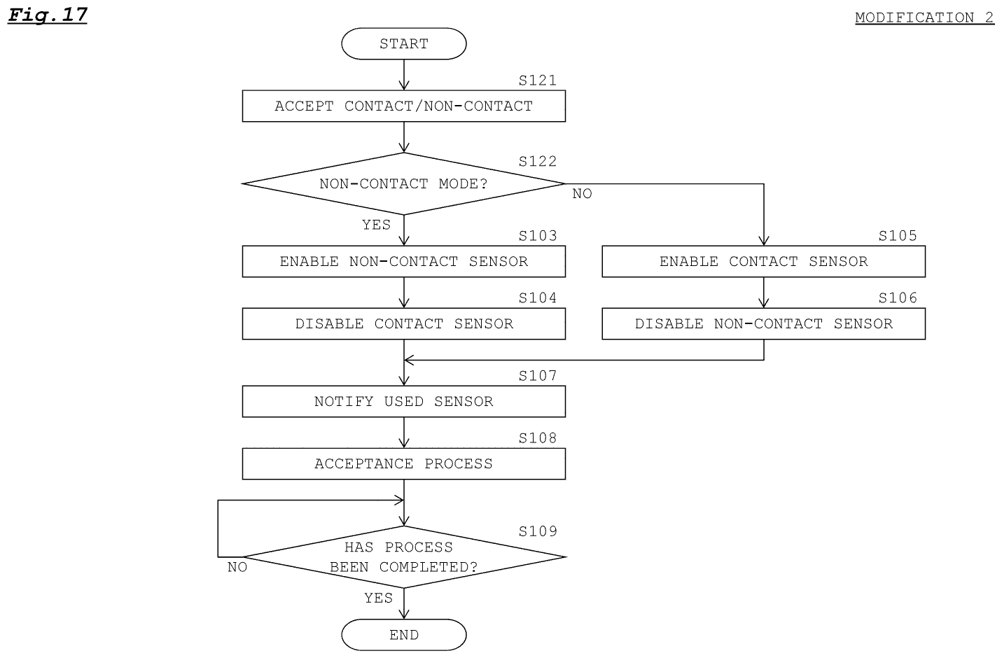

FIG. 17 is a flowchart showing switching control of detection means according to Modification 2.

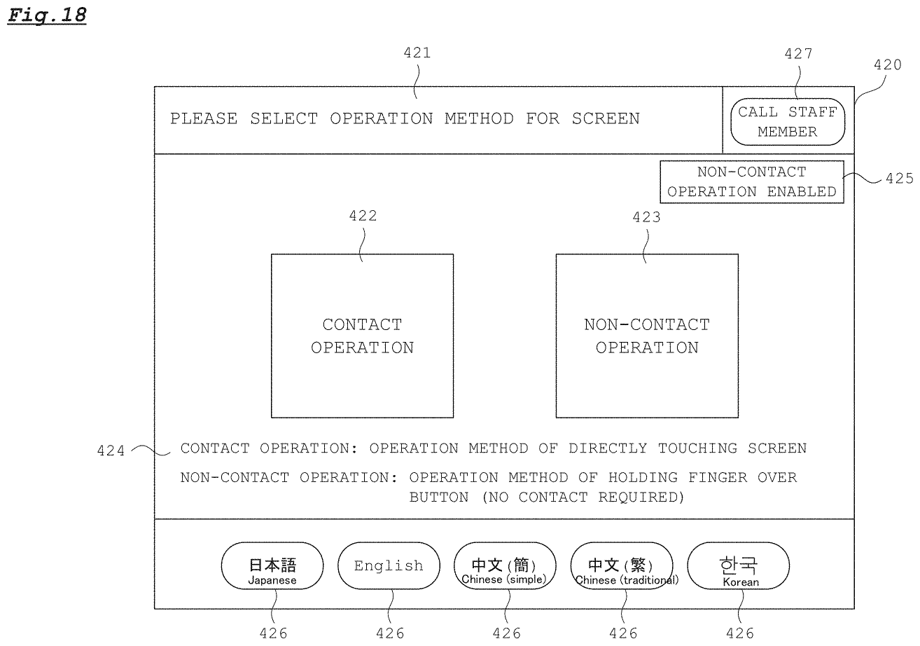

At the start of a transaction, the processor 301 accepts an operation for setting the detection means (S121). For example, the processor 301 displays an operation screen 420 shown in FIG. 18 on the display device 110 as an initial screen at the start of a transaction.

The operation screen 420 includes a message 421 which prompts the user to select the operation method for the screen, operation buttons 422 and 423 for selecting the operation method, and a notification text 424 which explains each operation method. By referring to the message 421 and the notification text 424, the user grasps that a contact type and a non-contact type are selectable as the operation method. Then, the user sets the operation method desired by the user by selecting either one of the operation buttons 422 and 423.

In addition, the operation screen 420 includes an image 425 for notifying the current operation method, operation buttons 426 for selecting the language used for the operation screen, and an operation button 427 for calling a staff member.

Referring back to FIG. 17, the processor 301 determines whether contact type operation or non-contact type operation has been selected by the user (S122). If contact type operation has been selected (S122: YES), the processor 301 executes processes in step S103 and steps subsequent thereto. If non-contact type operation has been selected (S122: NO), the processor 301 executes processes in step S105 and steps subsequent thereto. The processes in steps S103 and S105 and the steps subsequent thereto are the same as those in FIG. 5.

According to Modification 2, at the start of a transaction, the user can select the operation method (contact type/non-contact type) desired by the user. Accordingly, the convenience of the user can be improved.

After an operation with respect to the operation screen 420 of FIG. 18 is performed, the processor 301 displays the operation screen 400 of FIG. 6 or FIG. 15 and performs a settlement process. In this case, the operation method corresponding to the operation method selected by the user on the operation screen 420 is displayed in the image 403.

In this case as well, as shown in FIG. 15, the operation button 406 for switching the operation method during a transaction may be included in each operation screen. Accordingly, the user can select the operation method desired by the user on each operation screen. Therefore, the convenience of the user can be further improved.

In Modifications 1 and 2 described above, the detection means (contact type/non-contact type) used for operation detection can be switched in the transaction operation or the setting operation, but setting of the detection means may be accepted when the automatic transaction apparatus 10 is installed or depending on the operation or the like of the automatic transaction apparatus 10 after the installation. Accordingly, the method of input with respect to the operation screen can be optionally set between the contact type and the non-contact type depending on the situation of a facility where the automatic transaction apparatus 10 is installed.

<Modification 3>

In Embodiment 1 described above, the switching condition for switching between the contact sensor 120 and the non-contact sensor 130 is whether the operation screen is the screen that is to be used by the general user or the screen that is to be used by the manager. However, in Modification 3, the contact sensor 120 or the non-contact sensor 130 is set for each operation screen depending on the situation of each operation button included in the operation screen.

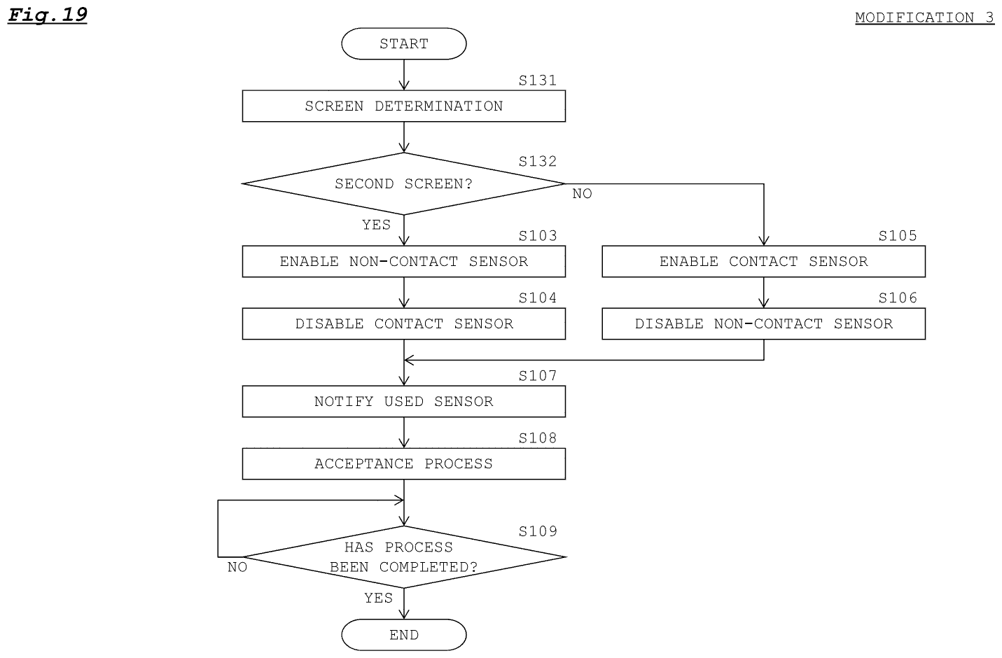

FIG. 19 is a flowchart showing switching control of detection means according to Modification 3.

When displaying an operation screen, the processor 301 determines whether the operation screen to be displayed is a first screen or a second screen (S131).

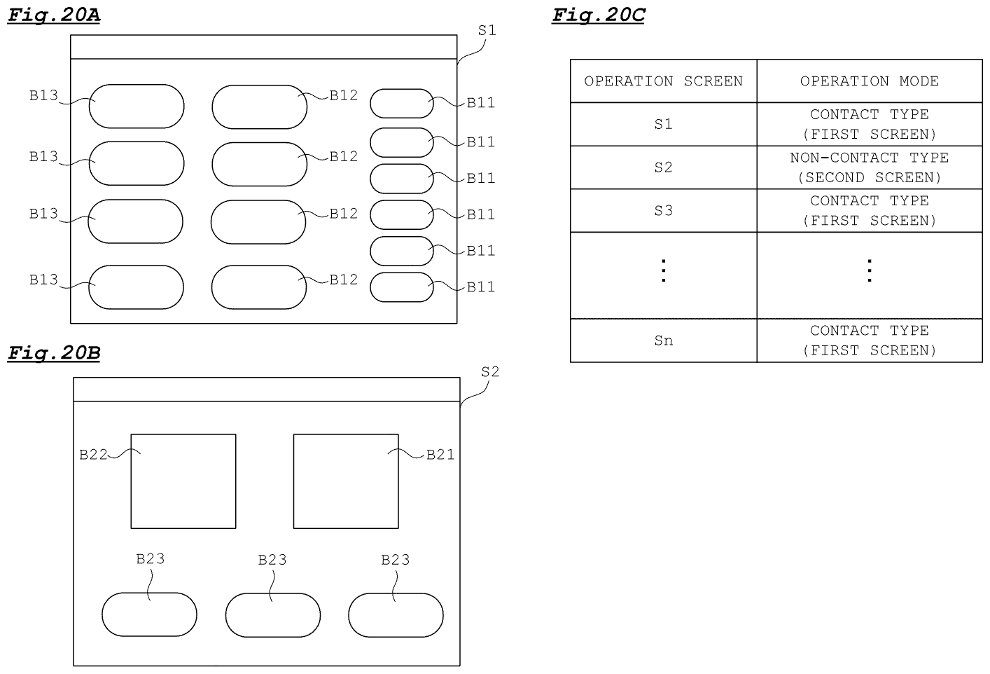

FIG. 20A and FIG. 20B are each a diagram showing a configuration example of the operation screen.

The number of operation buttons B11, B12, and B13 included in an operation screen S1 of FIG. 20A is larger than the number of operation buttons B21 and B23 included in an operation screen S2 of FIG. 20B. Therefore, in the operation screen S1, the sizes of the operation buttons B11, B12, and B13 are small, and the intervals between the operation buttons are narrow. In particular, the size of each operation button B11 is quite small, and the intervals between the adjacent operation buttons B11 are also quite narrow. Therefore, if the non-contact sensor 130 is used for the operation screen S1, an erroneous operation with respect to the operation button is likely to occur.

On the other hand, in the operation screen S2, since the number of operation buttons B21, B22, and B23 is small, the size of each operation button is large and the intervals between the operation buttons are also wide. The smallest operation buttons B23 also each have a relatively large size and the intervals therebetween are also wide. Therefore, even if the non-contact sensor 130 is used for the operation screen S2, an erroneous operation with respect to the operation button is less likely to occur.

From such a point of view, in Modification 3, which of the contact sensor 120 or non-contact sensor 130 is to be used is set for each operation screen in advance. Specifically, as shown in FIG. 20C, a table in which information indicating either contact type or non-contact type is associated with each operation screen is configured, and this table is held in the processor 301. In this table, each operation screen using the contact sensor 120 is the first screen, and each operation screen using the non-contact sensor 130 is the second screen. The processor 301 refers to this table and determines whether the operation screen to be displayed is the first screen or the second screen.

Referring back to FIG. 19, if the operation screen to be displayed is the second screen (S132: YES), the processor 301 executes processes in step S103 and steps subsequent thereto. If the operation screen to be displayed is the first screen (S132: NO), the processor 301 executes processes in step S105 and steps subsequent thereto. The processes in steps S103 and S105 and the steps subsequent thereto are the same as those in FIG. 5.

According to Modification 3, as shown in FIG. 19, whether the operation screen to be displayed is the first screen or the second screen is set as the switching condition for the contact sensor 120 and the non-contact sensor 130 (S131, S132). As illustrated in FIG. 20A and FIG. 20B, the second screen (operation screen S2) has a smaller number of operation buttons than the first screen (operation screen S1), and the sizes and intervals of the operation buttons are larger than those in the first screen (operation screen S1). In the control of FIG. 19, the contact sensor 120 is used if the operation screen to be displayed is the first screen, and the non-contact sensor 130 is used if the operation screen to be displayed is the second screen which has a smaller number of operation buttons than the first screen and in which the sizes and intervals of the operation buttons are larger than those in the first screen. That is, the contact sensor 120 is used for the first screen in which an erroneous operation with respect to the operation button is likely to occur if the non-contact sensor 130 is used, and the non-contact sensor 130 is used for the second screen in which an erroneous operation with respect to the operation button is less likely to occur even if the non-contact sensor 130 is used. Therefore, the user can smoothly advance an operation with respect to each operation screen while avoiding hygiene problems.

In the table of FIG. 20C, the operation method associated with each operation screen can be determined, for example, on the basis of whether or not the number of operation buttons included in the operation screen exceeds a predetermined threshold, or whether or not the minimum size or minimum interval of the operation buttons included in the operation screen exceeds a predetermined threshold.

For example, if the number of operation buttons included in the operation screen does not exceed the predetermined threshold, and both the minimum size and minimum interval of the operation buttons included in the operation screen exceed the predetermined thresholds, the contact sensor 120 (second screen) is associated with the operation screen. If the number of operation buttons included in the operation screen exceed the predetermined threshold or neither the minimum size nor minimum interval of the operation buttons included in the operation screen exceed the predetermined thresholds, the non-contact sensor 130 (first screen) is associated with the operation screen.

In this case, each threshold may be set on the basis of whether or not an operation with respect to each operation button can be properly performed when the non-contact sensor 130 is used. For example, the threshold for the sizes of the operation buttons can be specified for the sizes of the operation buttons in a direction perpendicular to the operation screen. In general, the user tries to operate the operation screen with a portion from a fingertip to the first joint of the finger. Therefore, in detection by the non-contact sensor 130, the actual detection position may shift from the operation position intended by the user, by the length from the fingertip to the first joint in addition to the error (gap G) shown in FIG. 4A and FIG. 4B. For example, even though the user intends to perform an operation with the belly of the finger, the fingertip may reach the detection surface S0 first and be detected by the non-contact sensor 130. In this case, between the operation position intended by the user and the actual detection position, an error corresponding to the distance between the fingertip and the belly of the finger occurs in addition to the error shown in FIG. 4A and FIG. 4B. From such a point of view, the threshold for the sizes of the operation buttons can be set in consideration of the average length from the fingertip to the first joint (for example, 20 mm). For example, the average length from the fingertip to the first joint (for example, 20 mm) may be set as the threshold for the sizes of the operation buttons.

<Modification 4>

In Modification 3 described above, either the contact sensor 120 or the non-contact sensor 130 is set for each operation screen. On the other hand, in Modification 4, either the contact sensor 120 or the non-contact sensor 130 is set for each operation button.

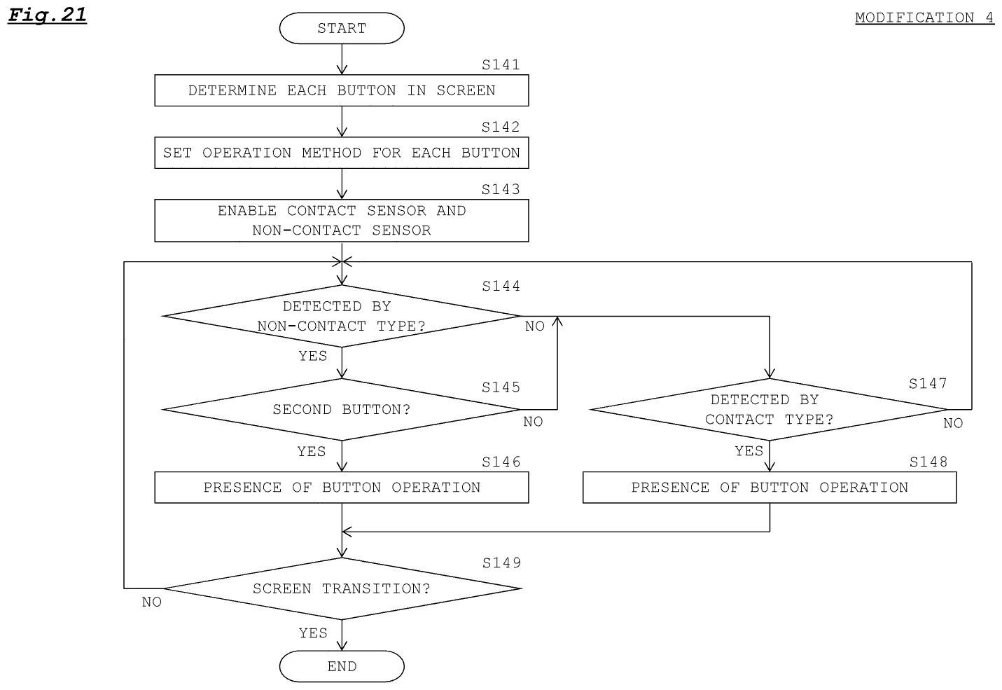

FIG. 21 is a flowchart showing switching control of detection means according to Modification 4.

When displaying an operation screen, the processor 301 determines whether each operation button included in the operation screen to be displayed is a first button or a second button (S141).

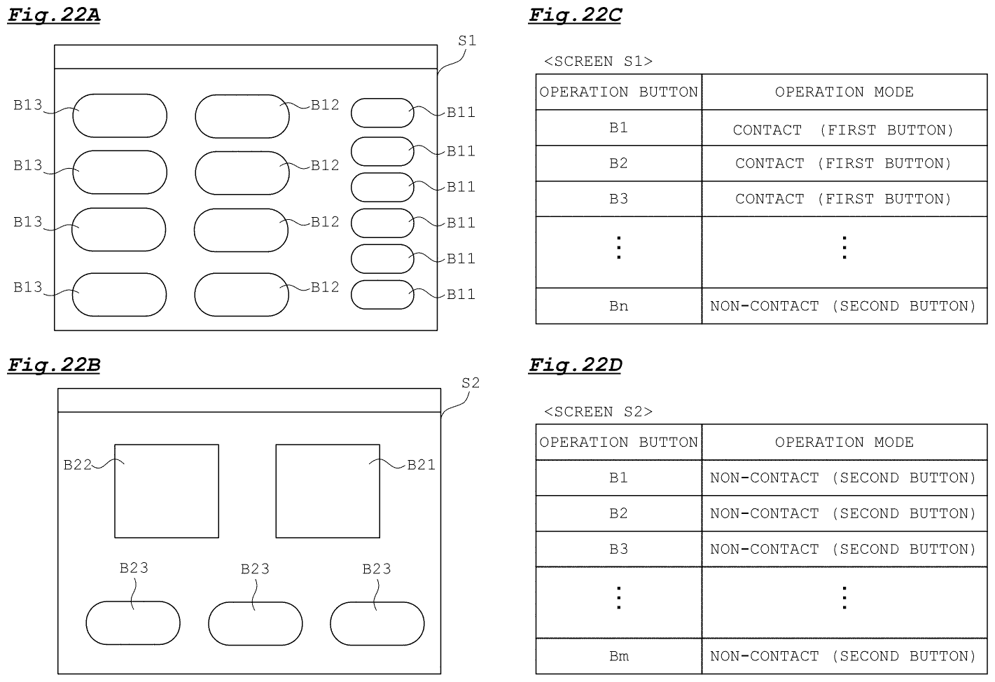

FIG. 22A and FIG. 22B are each a diagram showing a configuration example of the operation screen. The operation screens S1 and S2 of FIG. 22A and FIG. 22B are the same as the operation screens S1 and S2 shown in FIG. 20A and FIG. 20B.

In the operation screen S1, the size of each operation button B11 is small and the intervals between the adjacent operation buttons B11 are narrow. Therefore, if the non-contact sensor 130 is used for the operation buttons B11, an erroneous operation is likely to occur. On the other hand, even in the same operation screen S1, the size of each operation button B12 is large and the intervals between the adjacent operation buttons B12 are also wide. This point is the same for the operation buttons B13. Therefore, even in the same operation screen S1, the operation buttons B12 and B13 are less likely to be erroneously operated even if the non-contact sensor 130 is used.

In the operation screen S2, the operation buttons B21, B22, and B23 each have a large size and a wide interval with the adjacent operation button. Therefore, in the operation screen S2, an erroneous operation is less likely to occur even if the non-contact sensor 130 is used for any of the operation buttons.

From such a point of view, in Modification 4, whether to use the contact sensor 120 or the non-contact sensor 130 is set for each operation button in each operation screen in advance. Specifically, as shown in FIG. 22C and FIG. 22D, a table in which information indicating either contact type or non-contact type is associated with each operation button included in each operation screen is configured, and this table is held in the processor 301. In this table, each operation button using the contact sensor 120 is the first button, and each operation button using the non-contact sensor 130 is the second button. The processor 301 refers to this table and determines whether each operation button included in the operation screen to be displayed is the first button or the second button.

Referring back to FIG. 21, the processor 301 sets the contact sensor 120 for each first button, and sets the non-contact sensor 130 for each second button, among the operation buttons included in the operation screen to be displayed (S142). Then, the processor 301 enables both the contact sensor 120 and the non-contact sensor 130 (S143), and waits for input with respect to the operation screen.

If an operation with respect to the operation screen has been detected by the non-contact sensor 130 (S144: YES), the processor 301 identifies the operation button to be operated from the detection result, and determines whether or not the operation button is the second button (S145). If the operation button is the second button (S145: YES), the processor 301 determines that an operation with respect to the operation button has been performed (S146), and executes a process corresponding to the operation button.

On the other hand, if the operation button to be operated is the first button (S145: NO), the processor 301 further determines whether or not an operation with respect to the operation button has been detected as a series of operations by the contact sensor 120 (S147). Then, if an operation with respect to the operation button has been detected by the contact sensor 120 (S147: YES), the processor 301 determines that an operation with respect to the operation button has been performed (S148), and executes a process corresponding to the operation button.

After performing the process corresponding to the operation button to be operated as described above, the processor 301 determines whether or not the operation screen to be displayed transitions to another operation screen, according to the process (S149). If the screen does not transition to another operation screen, the processor 301 returns the processing to step S144 and executes the same process. On the other hand, if the screen transitions to another operation screen, the processor 301 ends the process of FIG. 21. In this case, the processor 301 executes the processes in step S141 and the steps subsequent thereto, on the operation screen after the transition.

According to Modification 4, as shown in FIG. 21, whether each operation button included in the operation screen to be displayed is the first button or the second button is set as the switching condition for the contact sensor 120 and the non-contact sensor 130 (S141, S142). As illustrated in FIG. 22A and FIG. 22B, the second buttons (operation buttons B12, B13) each have a larger size and a wider interval with the adjacent operation button than the first buttons (operation buttons B11). In the control of FIG. 21, the contact sensor is used if the operation button is the first button, and the non-contact sensor 130 is used if the operation button is the second button having a larger size and interval than the first button. That is, the contact sensor 120 is used for each first button to which an erroneous operation is likely to occur if the non-contact sensor 130 is used, and the non-contact sensor 130 is used for each second button to which an erroneous operation is less likely to occur even if the non-contact sensor 130 is used. Therefore, the user can smoothly advance an operation with respect to each operation button while avoiding hygiene problems.

In the tables of FIG. 22C and FIG. 22D, the operation method associated with each operation button can be determined, for example, on the basis of whether the size or interval of each operation button exceeds a predetermined threshold. For example, if both the size and the interval of the operation button exceed the predetermined thresholds, the non-contact sensor 130 (first screen) is associated with the operation button, and if either the size or the interval of the operation button does not exceed the predetermined threshold, the contact sensor 120 (second screen) is associated with the operation button. In this case, each threshold may be set on the basis of whether or not an operation with respect to each operation button can be properly performed when the non-contact sensor 130 is used.

### Embodiment 2

In Embodiment 1 and Modifications 1 to 4 described above, the detection means for input with respect to the operation screen or the operation button is switched between the contact sensor 120 and the non-contact sensor 130 according to the predetermined switching condition. On the other hand, in Embodiment 2, if input is detected only by the non-contact sensor 130, the detection result thereof is adopted, and if input is detected by both the non-contact sensor 130 and the contact sensor 120, the detection result of the contact sensor 120 is adopted.

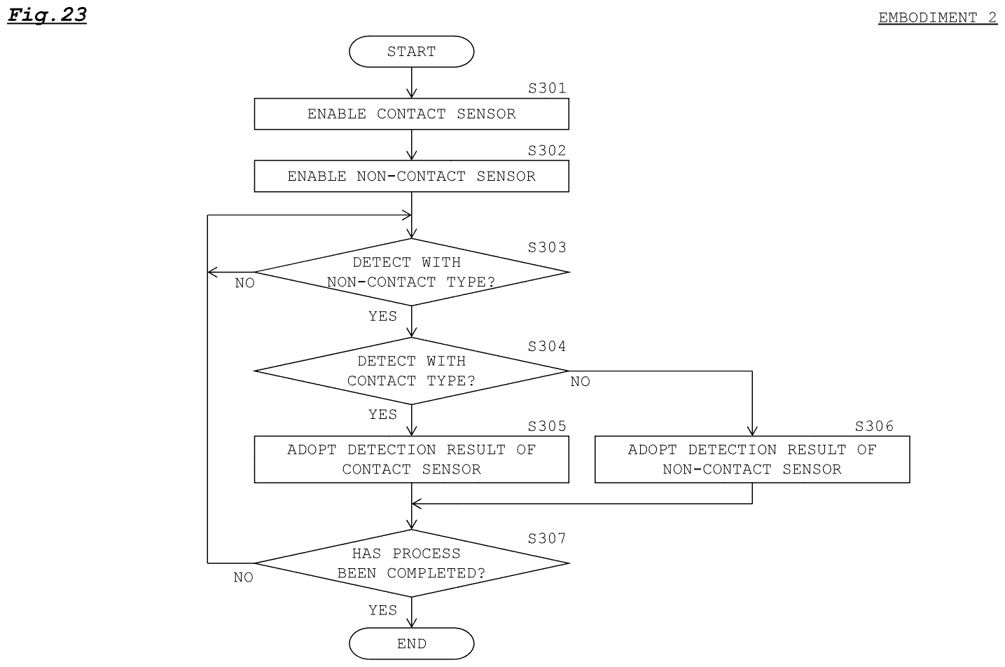

FIG. 23 is a flowchart showing an acceptance process for input with respect to an operation screen according to Embodiment 2.

In the acceptance process for the operation screen to be operated, the processor 301 enables both the contact sensor 120 and the non-contact sensor 130 (S301, S302). Then, the processor 301 determines whether or not input has been detected by the non-contact sensor 130 (S303). Since the detection surface S0 of the non-contact sensor 130 is farther from the operation screen than the detection surface (surface of the sensor 120) as shown in FIG. 2A and FIG. 2B, an operation with respect to the operation screen is normally detected by the non-contact sensor 130 before the contact sensor 120.

If input has been detected by the non-contact sensor 130 (S303: YES), the processor 301 further determines whether or not input has been detected by the contact sensor 120 as a series of operation motions (S304). The series of operation motions means that input is detected by the contact sensor 120 in a period when the infrared light emitted by the non-contact sensor 130 is blocked by the finger F1, that is, in a period when the output of some light receiver 132 falls.

If input has been detected by the contact sensor 120 as a series of operation motions (S304: YES), the processor 301 adopts the detection result of the contact sensor 120 (S305). On the other hand, if input has not been detected by the contact sensor 120 as a series of operation motions (S304: NO), the processor 301 adopts the detection result of the non-contact sensor 130 (S306). The processor 301 accepts the input with respect to the operation screen on the basis of the adopted detection result, and executes a process corresponding to the input.

After that, the processor 301 determines whether or not the acceptance process has been completed (S307). If the acceptance process has not been completed (S307: NO), the processor 301 returns the processing to step S303 and executes the same process. In this case, the operation screen is switched to another operation screen as appropriate. On the other hand, if the acceptance process has been completed (S307: YES), the processor 301 ends the process.

<Effects of Embodiment 2>

As shown in FIG. 23, if detection results are acquired by both the contact sensor 120 and the non-contact sensor 130 for an operation with respect to the operation screen (S304: YES, S304: YES), the processor 301 accepts input with respect to the operation screen by using the detection result by the contact sensor 120. Accordingly, while maintaining a hygienic input form using the non-contact sensor 130, it is possible to effectively suppress an erroneous operation by preferentially using the detection result of the more accurate contact sensor.

In Embodiment 1 and Modifications 1 to 3 described above, when the non-contact sensor 130 is used for detecting input with respect to the operation screen, the processor 301 disables the contact sensor 120. However, when the non-contact sensor 130 is used for detecting input with respect to the operation screen, the processor 301 may enable not only the non-contact sensor 130 but also the contact sensor 120. In this case, when the user touches the operation screen with the finger F1 in the mode in which the non-contact sensor 130 is used, the processor 301 may adopt the detection result of the contact sensor 120, not the detection result of the non-contact sensor 130, and advance the process, similar to Embodiment 2 described above. Accordingly, while maintaining a hygienic input form using the non-contact sensor 130, it is possible to use the detection result of the more accurate contact sensor.

### Embodiment 3

In Embodiment 2 described above, if input is detected by both the contact sensor 120 and the non-contact sensor 130, the detection result of the contact sensor 120 is adopted, but in Embodiment 3, of the detection results of the contact sensor 120 and the non-contact sensor 130, the detection result obtained earlier is adopted.

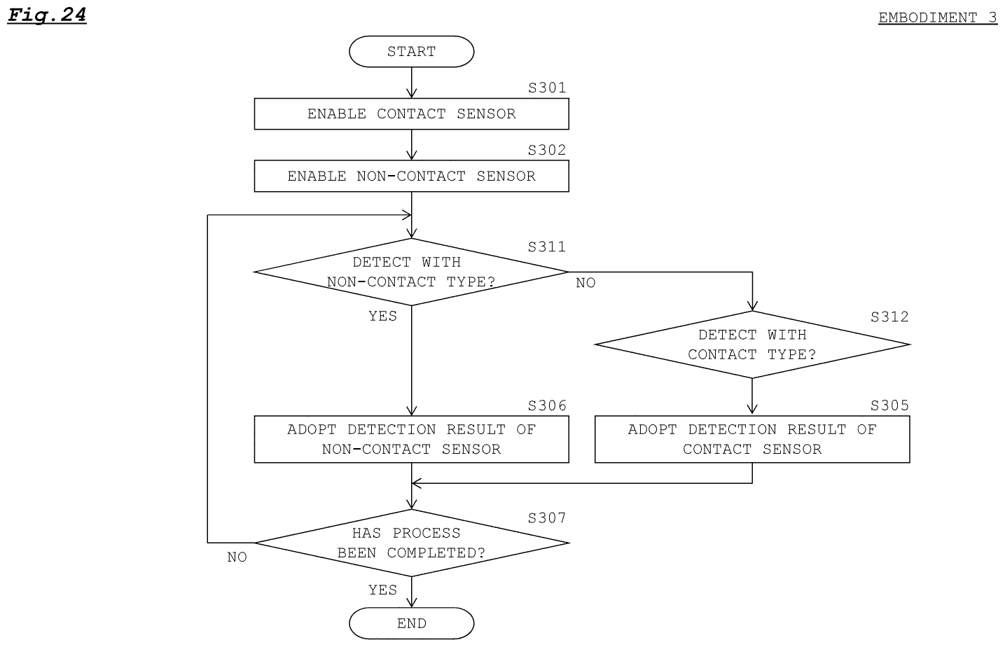

FIG. 24 is a flowchart showing an acceptance process for input with respect to an operation screen according to Embodiment 3.

In the flowchart of FIG. 24, steps S303 and S304 among the steps in the flowchart of FIG. 23 are replaced with steps S311 and S312. The processes in the other steps in FIG. 24 are the same as the processes in the corresponding steps in FIG. 23.

In the acceptance process for the operation screen to be operated, the processor 301 enables both the contact sensor 120 and the non-contact sensor 130 (S301, S302). Then, when a detection result is obtained by either the contact sensor 120 or the non-contact sensor 130, the processor 301 adopts the detection result obtained earlier (S311, S312, S305, S306). That is, if a detection result is obtained first by the non-contact sensor 130 (S311: YES), the processor 301 adopts the detection result obtained by the non-contact sensor 130 (S306), and if a detection result is obtained first by the contact sensor 120 (S311: NO, S312: YES), the processor 301 adopts the detection result obtained by the contact sensor 120 (S305).

In the detection method shown in FIG. 2A and FIG. 2B, as described above, since the detection surface S0 of the non-contact sensor 130 is farther from the operation screen than the detection surface (surface of the sensor 120) as shown in FIG. 2A and FIG. 2B, an operation with respect to the operation screen is normally detected by the non-contact sensor 130 before the contact sensor 120. Therefore, in the control of FIG. 24, it is normally determined in step S311 as YES, and the detection result of the non-contact sensor 130 is adopted. However, if a breakdown, temporary malfunction, or the like occurs in the non-contact sensor 130, a situation in which a detection result cannot be obtained by the non-contact sensor 130 can occur. In such a case, in the control of FIG. 24, it is determined in step S311 as NO, it is determined in step S312 as YES, and the detection result of the contact sensor 120 is adopted. Accordingly, the operation can be detected smoothly.

<Effects of Embodiment 3>

As described above, in the control of FIG. 24, input with respect to the operation screen is accepted by using the detection result obtained earlier, out of the detection results of the contact sensor 120 and the non-contact sensor 130. Accordingly, the process for the operation with respect to the operation screen can be performed more quickly and smoothly.

<Other Modifications>

Although Embodiments 1 to 3 and Modifications 1 to 4 of the present application have been described above, the present application is not limited by Embodiments 1 to 3 and each modification described above in any way, and various modifications other than the above may also be made to the embodiments of the present application.

For example, in Embodiment 1 described above, the height and the standing position in the right-left direction of the user are detected by the camera 21. However, the height and the standing position in the right-left direction of the user may be detected by a detector other than the camera 21. For example, a human sensor may be disposed individually for each height range or each range in the light-left direction, and the height or the standing position in the right-left direction of the user may be detected by the human sensor. In addition, in the case where an image taken by the camera 21 is analyzed and an operation direction with respect to the operation screen (moving direction of the finger) is acquired, the angle and the viewing angle of the camera 21 may be set such that an image of a region near the operation screen can be taken.

In the control of FIG. 10A to FIG. 13B, the detection position P20, the display position of the operation button B0, the response position P30 of the operation button B0, or the tilt angle of the operation image is corrected in the up-down direction and the right-left direction by using both the height and the standing position in the right-left direction of the user. However, the detection position P20, the display position of the operation button B0, the response position P30 of the operation button B0, or the tilt angle of the operation image may be corrected in the up-down direction by using only the height of the user. Alternatively, the detection position P20, the display position of the operation button B0, the response position P30 of the operation button B0, or the tilt angle of the operation image may be corrected in the right-left direction by using only the standing position in the right-left direction of the user.

In each embodiment and each modification described above, examples of the operation screen are shown, but these operation screens are merely examples, and the configuration of the operation screen, and the number, the sizes, the intervals, and the shapes of the operation buttons are not limited to those of these operation screens.

For example, the operation buttons may be other operation items such as an icon. In addition, in the operation screen 400 of FIG. 6, the image 403 which notifies that the non-contact sensor 130 is used may be located at another position in the operation screen 400, or may be displayed in a pop-up screen. Moreover, in the operation screen 500 of FIG. 16, the image 503 may be omitted, and the operation button corresponding to the currently used operation method, out of the operation buttons 513a and 513b, may be highlighted.

In each embodiment and each modification described above, an operation with respect to the operation screen is an operation of pressing an operation button, but an operation with respect to the operation screen detected by the contact sensor 120 and the non-contact sensor 130 is not limited thereto. For example, a swipe, a flick, and the like with respect to the operation screen may be detected by the contact sensor 120 and the non-contact sensor 130.

The configuration of the automatic transaction apparatus 10 is not limited to the configuration shown in FIG. 1A, and various modifications can be made to the configuration of the automatic transaction apparatus 10. For example, the automatic transaction apparatus 10 may be configured such that a human sensor for detecting the arrival of the user is disposed in the automatic transaction apparatus 10 and the automatic transaction apparatus 10 starts a transaction operation in response to the arrival of the user. In addition, the automatic transaction apparatus 10 may have a function other than the function for settlement. For example, the automatic transaction apparatus 10 may have a function of accepting a medical examination with a patient ID card and registering the medical examination in the medical practice system.

In each embodiment and each modification described above, the automatic transaction apparatus 10 which is installed at a medical institution and which is for settling a medical care fee has been illustrated, but the automatic transaction apparatus to which the present application can be applied is not limited thereto. For example, the present application may be applied to a ticket vending machine or a settlement machine installed at a station, a cafeteria, or the like, or an automatic transaction apparatus such as an automatic teller machine (ATM) and a cashier machine.

In addition to the above, the embodiments of the present application can be modified as appropriate within the scope of the claims.

What is claimed is:

1. An automatic transaction apparatus, comprising:
a display device configured to display an operation screen;
a contact sensor configured to detect a contact operation with respect to the operation screen;
a non-contact sensor configured to detect a non-contact operation with respect to the operation screen; and
processing circuitry configured to accept input with respect to the operation screen by selectively processing first signals from the contact sensor based on the contact operation or second signals from the non-contact sensor based on the non-contact operation.

2. The automatic transaction apparatus according to claim 1, wherein the processing circuitry is further configured to switch a sensor to be used for accepting input with respect to the operation screen, between the contact sensor and the non-contact sensor, based on a switching condition that specifies in advance which of the contact sensor or the non-contact sensor is to be used.

3. The automatic transaction apparatus according to claim 2, wherein in accordance with the switching condition, the non-contact sensor is used in a case that the operation screen is a screen to be operated by a general user, and the contact sensor is used in a case the operation screen is a screen to be operated by a manager.

4. The automatic transaction apparatus according to claim 2, wherein in accordance with the switching condition, the contact sensor is used in a case that the operation screen is a first screen, and the non-contact sensor is used in a case that the operation screen is a second screen including an operation button having a size larger than that of an operation button included in the first screen.

5. The automatic transaction apparatus according to claim 2, wherein in accordance with the switching condition, the contact sensor is used for a first button among operation buttons included in the operation screen, and the non-contact sensor is used for a second button having a size larger than that of the first button among the operation buttons included in the operation screen.

6. The automatic transaction apparatus according to claim 2, wherein in accordance with the switching condition, the contact sensor is used in a case that the operation screen is a first screen, and the non-contact sensor is used in a case that the operation screen is a second screen including a smaller number of operation buttons than a number of operation buttons included in the first screen.

7. The automatic transaction apparatus according to claim 2, wherein in accordance with the switching condition, the contact sensor is used for a first button among operation buttons included in the operation screen, and the non-contact sensor is used for a second button having a larger distance to the adjacent operation button than the first button among the operation buttons included in the operation screen.

8. The automatic transaction apparatus according to claim 1, wherein the processing circuitry is further configured to notify the user whether the operation screen is a screen on which an operation is accepted by the contact sensor or a screen on which an operation is accepted by the non-contact sensor.

9. The automatic transaction apparatus according to claim 1, wherein the processing circuitry is further configured to accept a setting of which of the contact sensor and the non-contact sensor is used for performing input.

10. The automatic transaction apparatus according to claim 9, wherein in a case that the processing circuitry accepts the setting in a transaction process, the processing circuitry validates the setting in the transaction process.

11. The automatic transaction apparatus according to claim 1, further comprising:
a detector configured to acquire information of an operation direction with respect to the operation screen, wherein
in a case that the processing circuitry accepts input through the non-contact sensor, the processing circuitry is further configured to correct a detection position detected by the non-contact sensor or a position of an operation button included in the operation screen based on the information acquired by the detector.

12. The automatic transaction apparatus according to claim 1, further comprising:
a detector configured to acquire information of an operation direction with respect to the operation screen; and
a drive mechanism configured to change a tilt angle of the display device, wherein
in a case that the processing circuitry accepts input through the non-contact sensor, the processing circuitry is further configured to control the drive mechanism to change the tilt angle of the display device based on the information acquired by the detector.

13. The automatic transaction apparatus according to claim 1, wherein operation buttons operated through the non-contact sensor are adjacent to each other only in a horizontal direction on the operation screen.

14. The automatic transaction apparatus according to claim 1, wherein the processing circuitry is further configured to enable both the contact sensor and the non-contact sensor and accept input with respect to the operation screen by selectively using detection results of the contact sensor and the non-contact sensor.

15. The automatic transaction apparatus according to claim 14, wherein in a case that detection results are acquired by both the contact sensor and the non-contact sensor for an operation with respect to the operation screen, the processing circuitry accepts input with respect to the operation screen by using the detection result by the contact sensor.

16. The automatic transaction apparatus according to claim 14 wherein the processing circuitry accepts input with respect to the operation screen by using the detection result obtained earlier, out of the detection results of the contact sensor and the non-contact sensor.

17. A control method for an automatic transaction apparatus, the control method comprising:
controlling a display device to display an operation screen;
accepting input with respect to the operation screen by selectively processing first signals from a contact sensor or second signals from a non-contact sensor, the contact sensor detecting a contact operation with respect to the operation screen and the non-contact sensor detecting a non-contact operation with respect to the operation screen.

18. An automatic transaction apparatus, comprising:
a display device configured to display an operation screen;
a non-contact sensor configured to detect an operation with respect to the operation screen;
processing circuitry configured to accept input with respect to the operation screen by processing signals from the non-contact sensor based on the operation; and
a detector configured to acquire information about an operation direction with respect to the operation screen, wherein
the processing circuitry corrects a detection position detected by the non-contact sensor or a position of an operation button included in the operation screen based on the information acquired by the detector.

19. A control method for an automatic transaction apparatus, the control method comprising:
controlling a display device to display an operation screen;
accepting input to the operation screen by processing signals from a non-contact sensor;
acquiring information about an operation direction with respect to the operation screen; and
correcting a detection position, with respect to the operation screen, detected by the non-contact sensor, or a position of an operation button included in the operation screen, based on the information.
